(19) United States
(12) Patent Application Publication
(10) Pub. No.: US 2014/0334265 A1
(43) Pub. Date: Nov. 13, 2014

(54) Direction of Arrival (DOA) Estimation Device and Method

(71) Applicant: Korea Advanced Institute of Science and Technology, Daejeon (KR)

(72) Inventors: Chang Dong YOO, Daejeon (KR); Jin Ho Choi, Daejeon (KR)

(73) Assignee: Korea Advanced Institute of Science and Technology, Daejeon (KR)

(21) Appl. No.: 14/070,716

(22) Filed: Nov. 4, 2013

(30) Foreign Application Priority Data
May 13, 2013 (KR) 10-2013-0053828

(51) Int. Cl. G01S 3/802

(52) U.S. Cl. CPC G01S 3/802
USPC 367/118

(57) ABSTRACT

A direction of arrival (DOA) estimation device and method are provided, in which the DOA estimation device includes a sensor unit configured to detect a signal and comprising two or more sensors to output sensor signals as a detect signal in response to the detected signal, and a controller configured to calculate statistical distribution data indicative of statistical distribution of each of the sensor signals outputted from the two or more sensors, respectively, retrieve statistical distribution data indicative of statistical distribution of source signal which is non-stationary signal entrained in the signal of the calculated statistical distribution data, and estimate DOA of the source signal based on the retrieved statistical distribution data.

### CROSS-REFERENCE TO RELATED APPLICATIONS

This application claims priority from Korean Patent Application No. 10-2013-0053828, filed on May 13, 2013, in the Korean Intellectual Property Office, the disclosure of which is incorporated herein by reference in its entirety.

### BACKGROUND

1. Field of the Invention

The present invention relates to a direction of arrival (DOA) estimation device, and more particularly, to a DOA estimation device based on 2p-th order signal with high-resolution capability in underdetermined case and noise signal subspace constraint optimization, and a method.

2. Description of the Related Art

Advancement in electronic, communication and mechanic technologies has enabled human race to live more comfortable. In many parts of human life, autonomous systems have been developed to move and work on behalf of human. The autonomous systems are so implemented to perceive signals from sound sources including human, airplanes, birds or submarines and behave appropriately according to the audio data as perceived. It is particularly possible to estimate the directions of arrival (DOA) of the sound source, based on the perception of the signals from the sound sources.

The DOA detecting device detects DOA through a receiver mounted thereon, using order the audio signal is outputted, and has shortcoming because the source signals have less data volume than vision and monotonous data form. However, the signals are still very important data, in consideration of the fact that the signals can compensate for those not recognizable to vision particularly in environment where there is no lighting, or where the presence of obstacle causes viewing out of the visual field.

Meanwhile, researchers have been working on the implementation of autonomous interface function on a robot which can receive and perceive user's calling voice or clapping sound through a receiver such as a microphone attached thereto and thus can be utilized as a replacement for an input system such as a camera or a keyboard. The technology is gaining increasing attention, for it provides ways for a robot to estimate DOA more accurately in response to sound source including user's voice.

One of the suggestions to the DOA estimation technology is made by Korean Patent Publication No. 10-2011-0057661(A) which discloses a moving object configured to calculate distance to sound source and accordingly move, and a control method thereof. The suggestion, however, has drawback of errors and long time for the moving object to estimate DOA.

Korean Patent Publication No. 10-2006-0000064 (A) suggests DOA estimation system of a speaker in non-stationary noise environment. This means that there is difficulty of tracking DOA in the stationary noise environment.

W. J. Zeng and X. L. Li suggest DOA estimation method for non-stationary sound signals in “High-resolution multiple wideband and nonstationary source localization with unknown number of sources” (IEEE Trans. Signal Process., vol. 58, pp. 3125-3136, June 2010). However, the suggestion has drawbacks of low resolution and accuracy of DOA estimation, when the number of sound sources is not known.

### SUMMARY OF THE INVENTION

A technical object of the present invention is to provide high spatial resolution DOA estimation in underdetermined situation.

Another technical object of the present invention is to provide high-accuracy DOA estimation in underdetermined situation.

Yet another technical object of the present invention is to retrieve more sound sources in underdetermined situation.

In one embodiment, a direction of arrival (DOA) estimation device is provided, which may include a sensor unit configured to detect a signal and comprising two or more sensors to output sensor signals as a detect signal in response to the detected signal, and a controller configured to calculate statistical distribution data indicative of statistical distribution of each of the sensor signals outputted from the two or more sensors, respectively, retrieve statistical distribution data indicative of statistical distribution of source signal which is non-stationary signal entrained in the signal of the calculated statistical distribution data, and estimate DOA of the source signal based on the retrieved statistical distribution data.

The number of sensors included in the sensor unit may be equal to, or less than the number of sources.

The statistical distribution data may include data indicative of variation of the source signal over time and property changes.

The calculated statistical distribution may include at least one of Gaussian distribution, non-Gaussian distribution, Laplace distribution, and beamforming distribution.

The controller may calculate cumulant matrix with the calculated statistical distribution data, and calculate the cumulant matrix using:

Kₓ_{ₖ}^{(ρ)}=Aₖ^{(ρ)}Dₛ_{ₖ}^{(ρ)}+K_{z}_{ₖ}^{(ρ)} [Mathematical Expression]

where, Kₓ_{ₖ}^{(ρ)} denotes 2pth-order cumulant matrix in kth frequency bin, Aₖ^{(ρ)} denotes virtual array manifold vector of kth frequency bin, and K_{z}_{ₖ}^{(ρ)} denotes noise signal which is stationary.

The controller may include a pre-processor configured to convert the sensor signals into digital signals, a signal analyzer configured to calculate statistical distribution data indicative of statistical distribution of the converted digital signals, retrieve statistical distribution data indicative of statistical distribution of the source signals by eliminating data about noise signal entrained in the signal from the calculated statistical distribution data, and calculate spatial spectrum about the number of sources of the digital signals and direction, using the retrieved statistical distribution data, and a direction estimator configured to estimate the DOA based on peaks of the calculated spatial spectrum of the digital signals.

The signal analyzer may calculate the spatial spectrum using:

(wₖ^{(ρ)})_{θ}^{H}Bₖ^{(ρ)}(wₖ^{(ρ)})_{θ}=(cₖ^{(ρ)})_{θ} [Mathematical Expression]

and

(wₖ^{(ρ)})_{θ}^{H}Bₖ^{(ρ)}(wₖ^{(ρ)})_{θ}=(cₖ^{(ρ)})_{θ} [Conditional Expression]

where, (wₖ^{(ρ)})_{θ} denotes weight vector of kth frequency bin, aₖ^{(ρ)}(θᵢ) denotes virtual array manifold vector of θᵢ in kth frequency bin, Bₖ^{(ρ)} denotes non-singular matrix, and cₖ^{(ρ)} is an arbitrary nonzero real constant.

The signal analyzer may calculate the non-singular matrix Bₖ^{(ρ)} using the following mathematical expression, depending on whether the number of sources (I) is known, and when I is not known:

$${B}_{k}^{( ρ )} = \{ \begin{matrix}{U}_{s , k}^{( ρ )} ( {\sum }_{s , k}^{( ρ )} ) {( {U}_{s , k}^{( ρ )} )}^{H} + {α}_{k}^{( ρ )} {I}_{{M}^{2 ρ}} , known I \\ {C}_{{x}_{k}}^{( ρ )} + {α}_{k}^{( ρ )} {I}_{{M}^{2 ρ}} , unknown I\end{matrix} \qquad [ Mathematical Expression ]$$

where U_{s,k}^{(ρ)} is eigenvector [symbol] ( [symbol] ₓ_{ₖ}^{(ρ)}), which corresponds to non-zero eigenvalue, Σ_{s,k}^{(ρ)} is eigenvector [symbol] ( [symbol] ₓ_{ₖ}^{(ρ)}), which corresponds to zero eigenvalue, I denotes the number of sources, I_{M}_{^{2ρ}} denotes M^{2ρ}×M^{2ρ} unit matrix, αₖ^{(ρ)} is eigenvector associated with eigenvalues corresponding to both eigenvector [symbol] ( [symbol] ₓ_{ₖ}^{(ρ)}) representing source signal and eigenvector [symbol] ( [symbol] ₓ_{ₖ}^{(ρ)}) representing noise signal, and [symbol] ₓ_{ₖ}^{(ρ)} is noise-eliminated and dimension-adjusted 2pth-order cumulant matrix.

For the known I, the signal analyzer may calculate the) non-singular matrix Bₖ^{(ρ)} using the eigenvector U_{s,k}^{(ρ)} and the eigenvector Σ_{s,k}^{(ρ)}, calculate Lagrange multiplier Gₖ^{(ρ)}, using the calculated non-singular matrix Bₖ^{(ρ)}, calculate optimum weight vector (wₖ^{(ρ)})_{θ,opt} using the calculated Gₖ^{(ρ)}, and calculate eigenvector αₖ^{(ρ)} using the calculated (wₖ^{(ρ)})_{θ,opt} and the eigenvector U_{n,k}^{(ρ)}.

For the unknown I, the signal analyzer may calculate the non-singular matrix Bₖ^{(ρ)} using the 2pth-order cumulant matrix [symbol] ₓ_{ₖ}^{(ρ)}, calculate Lagrange multiplier Gₖ^{(ρ)} using the calculated non-singular matrix Bₖ^{(ρ)}, calculate optimum weight vector (wₖ^{(ρ)})_{θ,opt} using the calculated Gₖ^{(ρ)}, and calculate eigenvector αₖ^{(ρ)} using the calculated (wₖ^{(ρ)})_{θ,opt} and the 2pth-order cumulant matrix [symbol] ₓ_{ₖ}^{(ρ)}.

The direction estimator may estimate the DOA based on look direction of the source signal corresponding to the eigenvector αₖ^{(ρ)} having the largest non-singular value among the non-singular values calculated using the 2pth-order cumulant matrix [symbol] ₓ_{ₖ}^{(ρ)}.

In one embodiment, a direction of arrival (DOA) estimation method is provided, which may include detecting a signal and outputting sensor signals as a detect signal in response to the detected signal, calculating statistical distribution data indicative of statistical distribution of each of the outputted sensor signals, respectively, and retrieving statistical distribution data indicative of statistical distribution of source signal which is non-stationary signal entrained in the signal of the calculated statistical distribution data, and estimating DOA of the source signal based on the retrieved statistical distribution data.

With the DOA estimation device and method according to the present invention, it is possible to provide high spatial resolution DOA estimation in underdetermined situation.

Further, it is possible to provide high-accuracy DOA estimation in underdetermined situation.

Further, it is possible to retrieve more sound sources in underdetermined situation.

### BRIEF DESCRIPTION OF THE DRAWINGS

The foregoing and/or other aspects according to an embodiment will be more apparent upon reading the description of certain exemplary embodiments with reference to the accompanying drawings, in which:

FIG. 1 illustrates a DOA estimation device according to an embodiment;

FIG. 2 is a block diagram of a DOA estimation device according to an embodiment;

FIG. 3 is a block diagram of a controller of a DOA estimation device according to an embodiment;

FIG. 4 is a graphical representation of high-resolution capability of DOA device according to an embodiment;

FIG. 5 is a graphical representation of high-resolution capability of a DOA estimation device according to another embodiment;

FIG. 6 is a graphical representation of high-resolution capability of a DOA estimation device according to yet another embodiment;

FIG. 7 is a graphical representation of high-resolution capability of a DOA estimation device according to yet another embodiment;

FIG. 8 is a graphical representation of high accuracy of a DOA estimation device according to an embodiment;

FIG. 9 is a graphical representation of high accuracy of a DOA estimation device according to another embodiment;

FIG. 10 is a graphical representation of high accuracy of a DOA estimation device according to yet another embodiment;

FIG. 11 is a graphical representation of high accuracy of a DOA estimation device according to yet another embodiment;

FIG. 12 is a graphical representation of high accuracy of a DOA estimation device according to yet another embodiment;

FIG. 13 is a graphical representation of high accuracy of a DOA estimation device according to yet another embodiment;

FIG. 14 is a graphical representation of high accuracy of a DOA estimation device according to yet another embodiment;

FIG. 15 is a graphical representation of high accuracy of a DOA estimation device according to yet another embodiment;

FIG. 16 is a graphical representation showing the number of retrieved sound sources by a DOA estimation device according to an embodiment;

FIG. 17 is a graphical representation showing the number of retrieved sound sources by a DOA estimation device according to another embodiment;

FIG. 18 is a graphical representation showing the number of retrieved sound sources by a DOA estimation device according to yet another embodiment;

FIG. 19 is a flowchart provided to explain a DOA estimation method according to an embodiment;

FIG. 20 is a flowchart provided to further explain operation at S140 of FIG. 19 in detail; and

FIG. 21 is a flowchart provided to further explain operation at S150 of FIG. 19 in detail.

### DETAILED DESCRIPTION OF EXEMPLARY EMBODIMENTS

The present invention will be explained below with reference to embodiments and drawings.

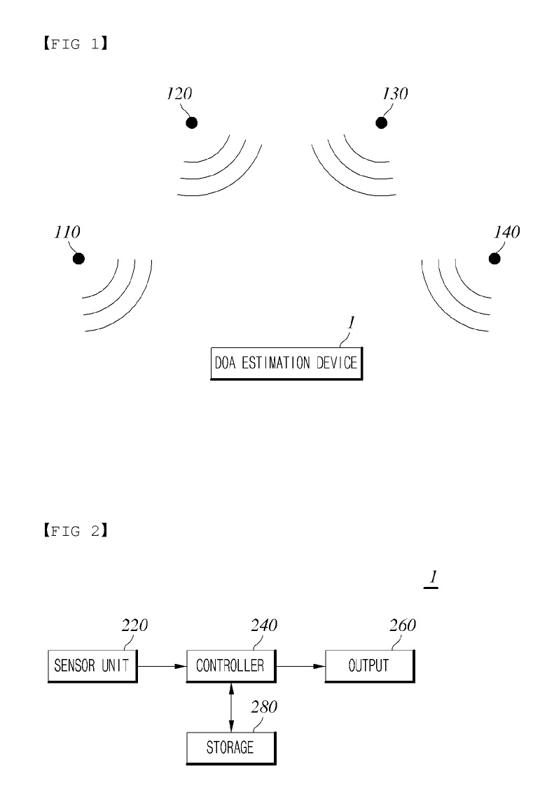

FIG. 1 illustrates a DOA estimation device according to an embodiment.

Referring to FIG. 1, the DOA estimation device 1 operates to estimate direction of arrival (DOA) of the signals. The DOA estimation device 1 may detect the signals outputted from the sound sources. The DOA estimation device 1 may retrieve source signals which are non-stationary, based on the detected signals, and calculate statistical distribution of the retrieved source signals. Based on the calculated statistical distribution, the DOA estimation device 1 may estimate the DOA of the impinging source signals. The DOA device 1 may be used for the purpose of at least one of: radar, sonar and biomedical signal retrieval.

The sound source can be where the signals are generated. The sound source may be at least one of car, bird, airplane, submarine, missile, and people. The sound source in terms of sound perception system may be speakers in a room. The sound source may be referred to as ‘source’.

The signal may be sound outputted from the source. The signal may be at least one of electromagnetic wave signal, biomedical signal, sonar signal and sound wave signal. The signal may be referred to as ‘source signal’.

The source signal may be the sensor signal which is received through the sensor and from which noise signal is eliminated.

The DOA estimation device 1 may operate when the number of sources is greater than the number of sensors provided to detect the source signals. The source signal may include signal from the source and noise signal. The DOA estimation device 1 may receive non-stationary, source signal and stationary noise signal.

The source signal and noise signal may be zero-mean normal distribution. Further, the source signal and noise signal may include at least one statistical distribution of Gaussian, non-Gaussian, Laplace and beamforming distributions.

The statistical distribution may be signal characteristic identical to that of the Gaussian, non-Gaussian, Laplace and beamforming distribution.

The DOA estimation device 1 may detect signals outputted from sources 110, 120, 130, 140, and analyze the detected signal, to thus estimate the DOA. The DOA estimation device 1 many have a less number of sensors than sources. The sensor may be at least one of radar, microphone and ultrasonic sensor.

The DOA estimation device 1 may convert the detected signal into digital signal. The DOA estimation device 1 may filter out noise signal entrained in the converted signal. The DOA estimation device 1 may analyze the statistical distribution included in the source signal as filtered, for the purpose of DOA estimation.

The DOA estimation device 1 provides high spatial resolution with respect to source signals and high accuracy of DOA estimation, even when the number of sensors is less than the sources.

The ‘spatial resolution’ refers to the degree of accuracy of determining look direction, when several sources have similar look directions. That is, when it is assumed that source 110 outputs at 30°, and source 120 outputs at 32°, a high spatial resolution DOA estimation device can detect the source 110 and the source 120 as two sources. On the contrary, a DOA estimation device with low spatial resolution would perceive the source 110 and the source 120 as one single source.

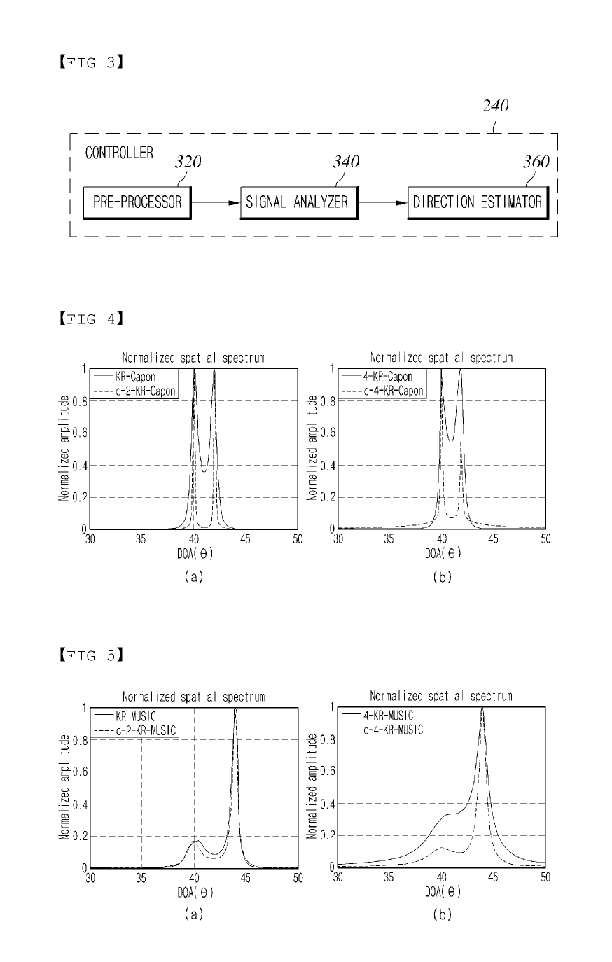

FIG. 2 is a block diagram of a DOA estimation device according to an embodiment.

Referring to FIG. 2, the DOA estimation device 1 may detect the non-stationary source signal and stationary noise signal and estimate the DOA of the detected signals. The DOA estimation device 1 may estimate DOA of non-stationary source signals, in underdetermined situation, i.e., in situation where there are more sources than sensors.

The DOA estimation device 1 may include a sensor unit 220, a controller 240, an output 260 and a storage 280.

The sensor unit 220 may detect the signals generated from the source. That is, the sensor unit 220 may detect the source signal which is non-stationary, and noise signal which is stationary. The signal detected and received at the sensor unit 220 may be referred to as a ‘sensor signal’. The sensor signal may include a signal that includes source signal and noise signal.

The sensor unit 220 may detect a signal in a range of 0°˜180°. Further, the sensor unit 220 may be stationed, i.e., fixed in position. The sensor unit 220 may include at least two or more sensors. The sensor unit 220 may have equal or less number of sensors to or than sources. The signal detected at the sensor unit 220 may have time delay, depending on locations of the respective sensors. The sensor unit 220 may include at least one of radar, microphone and ultrasonic sensor.

The controller 240 may retrieve source signal, which is non-stationary, from the signal detected at the sensors of the sensor unit 220, and calculate statistical distribution of the retrieved source signal. The controller 240 may estimate DOA of the source that outputs the source signal, based on the statistical distribution data calculated with respect to each of the source signals.

The controller 240 may convert the source signal and noise signal in analogue form into digital signals. The controller 240 may filter out noise signal entrained in the converted signal. The controller 240 may analyze the filtered signal. At this time, the controller 240 may utilize different algorithms, depending on whether the number of sources is known or not known.

When the number of sources is known, the controller 240 may utilize c-2p-KR-multiple signal classification (MUSIC) algorithm. The c-2p-KR-MUSIC algorithm is the variation of 2p-KR-MUSIC algorithm, to thus achieve higher spatial resolution and accuracy.

When the number of sources is not known, the controller 240 may utilize c-2p-KR-Capon algorithm. The c-2p-KR-Capon algorithm is the variation of 2p-KR-Capon algorithm, to thus achieve higher spatial resolution and accuracy.

The controller 240 may perform DOA estimation based on the calculated statistical distribution data.

The statistical distribution data may include variations of the source signal over time and characteristic variations. The ‘characteristic variation’ may include at least one of signal amplitude, periodicity, and error according to inter-sensor delay.

The output 260 may output the data with DOA as estimated at the controller 240. The output 260 may be at least one of monitor, projector, liquid crystal, and head-up display that outputs screen on a front glass.

The storage 280 may store the DOA estimation algorithms for use at the controller 240. The storage 280 may also store data about 2p-order statistical characteristic.

Accordingly, the DOA estimation device 1 may compare and analyze the data of the respective sensors, using the statistical distribution data of the controller 240 based on the signals as detected at the respective sensors of the sensor unit 220. The DOA estimation device 1 may thus estimate the DOA, using the data obtained as a result of comparison and analysis.

FIG. 3 is a block diagram of the controller of the DOA estimation device according to an embodiment of the present invention.

Referring to FIG. 3, the controller 240 may convert the signal into digital form and eliminate the noise signal from the digital signal. The controller 240 may calculate spatial spectrum of the number of sources and direction of the digital signal, using the statistical distribution of the eliminated digital signal. The controller 240 may estimate the DOA based on the peak of the spatial spectrum calculated from the digital signal.

The pre-processor 320 may convert an analogue signal into a digital signal. The pre-processor 320 may include an analog-to-digital converter (ADC). The ADC may convert the source signal and noise signal into digital signals.

The pre-processor 320 may consider uniform linear array (ULA) with M sensors uniformly spaced dₛ distance apart. When I^{(I>M)} wide-band sources {sᵢ(t)|i=0, . . . , I−1} located at distinct directions impinge on the ULA, the received sensor signal xₘ(t) at the mth sensor may be modeled as:

$${x}_{m} ( t ) = {\sum }_{i = 0}^{I - 1} {α}_{i} {s}_{i} ( t - {τ}_{mi} ) + {z}_{m} ( t ) ; \\ m = 0 , … , M - 1 \qquad [ Mathematical Expression 1 ]$$

where αᵢ and τₘᵢ are an attenuation factor due to propagation effect. The pre-processor 320 may delay the propagation time from the first sensor (m=0) of the ith source to the mth sensor. Here, zₘ(t) is the noise at the mth sensor. Taking the Short-Time Discrete Fourier Transform (STDFT) of xₘ(t), the pre-processor 320 may assume sampling rate fₛ. The pre-processor 320 may express the frequency component of the mth sensor at the kth frequency bin and time n as:

$$\begin{matrix}{X}_{m , k} [ n ] = {\sum }_{τ = - ∞}^{∞} {x}_{m} [ n - τ ] w [ τ ] {e}^{- j \frac{2 nk}{N} τ} \\ = {\sum }_{i = 0}^{I - 1} {α}_{i} {S}_{i , k} [ n ] {e}^{- j ( \frac{2 nk}{N} ( {τ}_{mi} {f}_{s} ) )} + \\ = {Z}_{m , k} [ n ] , m = 0 , … , M - 1 , \\ k = 0 , … , N - 1\end{matrix} \qquad [ Mathematical expression 2 ]$$

where xₘ[n] is the discrete-time received sensor signal of sₘ(t). w[n] is a window sequence and N is the number of Discrete Fourier Transform (DFT) points. Let S_{i,k}[n] and A_{m,k}[n] be the STDFTs of sᵢ(t) and zₘ(t) respectively. The pre-processor 320 may assume far-field scenario such that when the size of the sensor array aperture is much smaller compared to the distance from the sources to the sensor array, τₘᵢ can be denoted as:

$${τ}_{mi} = \frac{{md}_{s} sin {θ}_{i}}{c} \qquad [ Mathematical expression 3 ]$$

where θᵢ is the ith source DOA, AND c is the source velocity. When αᵢ=1, the pre-processor 320 may define the array manifold vector of θᵢ at the kth frequency bin as:

$${a}_{k} ( {θ}_{i} ) = {[ {a}_{0 , k} ( {θ}_{i} ) , {a}_{1 , k} ( {θ}_{i} ) , … , {a}_{M - 1 , k} ( {θ}_{i} ) ]}^{T} ( ε {M \times 1}^{} ) \\ where \\ {a}_{m , k} ( {θ}_{i} ) = exp ( - j ( \frac{2 π k}{N} ) ( \frac{{md}_{s} sin {θ}_{i}}{c} {f}_{s} ) ) . \qquad [ Mathematical expression 4 ]$$

The source signals may be zero-mean normal distribution, and non-stationary, and may be either Gaussian or non-Gaussian. The source signals may be mutually independent. The noise signal may be zero-mean normal distribution and stationary, and may be either Gaussian or non-Gaussian. The noise signal may be either spatially correlated or uncorrelated. The source signal and noise signal may be mutually independent.

The pre-processor 320 may filter out noise signal from the converted signal. The pre-processor 320 may include at least one of low pass filter and band pass filter.

Let v=[V₀, V₁, . . . , V_{L-1}] be any L-dimensional complex random vector and g_{ρ}^{L}=[g₀, g₁, . . . , g₂_{_{ρ-1}}] where gⱼε{0, 1, . . . , L−1} be a 2p length vector whose element indexes an element of an L-length vector. Given g_{ρ}^{dim(v)} where dim(v) is the dimension of v, the pre-processor 320 may define 2pth-order cumulant of V based on the Lenov-Shiryaev formula as:

$$K ( v , {g}_{ρ}^{dim ( v )} ) = Cum [ {V}_{{g}_{0}}^{*} , {V}_{{g}_{1}} , {V}_{{g}_{2}}^{*} , … , {V}_{{g}_{2 ρ} - 1} ] = {\sum }_{p = 1}^{2 ρ} {( - 1 )}^{p - 1} ( p - 1 ) ! E ( {\prod }_{j ∈ {S}_{1}}^{ } {V}_{{g}_{j}}^{{e}_{j}} ) \times E ( {\prod }_{j ∈ {S}_{2}}^{ } {V}_{{g}_{j}}^{{e}_{j}} ) … E ( {\prod }_{j ∈ {S}_{p}}^{ } {V}_{{g}_{j}}^{{e}_{j}} ) \qquad [ Mathematical expression 5 ]$$

where (S₁, S₂, . . . , Sₚ) describes all the partitions in p sets of (0, 1, . . . , 2ρ−1) and E(•) denotes the expectation. Here, ε_{2q}=−1, or otherwise, ε_{2q+1}=1 for q=0, 1, 2, . . . , ρ−1 such that

$${V}_{{q}_{j}}^{1} = {V}_{{g}_{i}}$$

$$and$$

$${V}_{{g}_{i}}^{- 1} = {V}_{{g}_{j}}^{*}$$

where * denotes the conjugate operator. Let the total ordered set of possible g_{ρ}^{L} be Ω(g_{ρ}^{L}) and its cardinality |Ω(g_{ρ}^{L})| be L^{2ρ}. Each element of Ω(g_{ρ}^{L}) can be indexed by d where d=Σⱼ₌₀^{2ρ-1}gⱼL^{2ρ-j-1}, 0≦d≦L^{2ρ}−1 Here, the (L)th element of Ω(g_{ρ}^{L}) may be denoted as g_{ρ}^{L}(d). g_{ρ}^{L}(d) may be viewed as a 2p length L-ary representation of d [symbol] . The pre-processor 320 may have the received sensor signal vector of the kth frequency bin xₖ[n]=[X_{0,k}[n], X_{1,k}[n], . . . , X_{M-1,k}[n]) (ε [symbol] ^{1×M}) with g_{ρ}^{dim(x}^{ₖ}^{[n])}(d) at time n as:

$$K ( {x}_{k} [ n ] , {g}_{ρ}^{dim ( {x}_{k} [ n ] )} ( d ) ) = {\sum }_{i = 0}^{I - 1} \underbrace{{a}_{{m}_{0} , k}^{*} ( {θ}_{i} ) {a}_{{m}_{1} , k} ( {θ}_{i} ) … {a}_{{m}_{2 ρ - 2} , k} ( {θ}_{i} ) {a}_{{m}_{2 ρ - 1} , k} ( {θ}_{i} )}_{2 ρ - 1 multiplications} \times K ( {s}_{k} [ n ] , i \cdot {1}_{2 ρ} ) + K ( {z}_{k} [ n ] , {g}_{ρ}^{dim ( {z}_{k} [ n ] )} ( d ) ) \qquad [ Mathematical expression 6 ]$$

where 1_{2ρ} is a 2p-length vector whose elements are all ones. Here, [symbol] (sₖ[n], i·1_{2ρ}) and [symbol] (zₖ[n], g_{ρ}^{dim(z}^{ₖ}^{[n])}(d)) are the 2pth-order cumulants of source vector of the kth frequency bin sₖ[n]=[S_{0,k}[n], S_{1,k}[n], . . . , S_{1-1,k}[n]](ε [symbol] ^{1×I}) and noise vector of the kth frequency bin zₖ[n]=[Z_{0,k}[n], Z_{1,k}[n], . . . , Z_{M-1,k}[n]](ε [symbol] ^{1×M}) at time n, respectively.

For non-stationary sources, the pre-processor 320 may determine [symbol] (sₖ[n], g_{ρ}^{dim(s}^{ₖ}^{[n])}(d))=0, when g_{ρ}^{dim(s}^{ₖ}^{[n])}(d)≠i·1_{2ρ}. The pre-processor 320 may arrange [symbol] (zₖ[n], g_{ρ}^{dim(z}^{ₖ}^{[n])}(d)) defined in Mathematical Expression 6 as a column at time n, indexing d from 0 to M^{2ρ}−1 in ascending order and stack the columns at time ns for b stationary segments. The signal analyzer 340 may calculate statistical distribution of the source signal as converted at the pre-processor 320. Further, the signal analyzer 340 may analyze and calculate the statistical distribution data included in the source signal, using the high 2pth-order statistical distribution data including 2pth-order statistical distribution data.

The signal analyzer 340 may analyze signals, using different algorithms depending on whether the number of sources is known or not. The signal analyzer 340 may use MUSIC algorithm-based c-2p-MUSIC algorithm, when the number of sources is known. The signal analyzer 340 may utilize Capon algorithm-based c-2p-Canpon algorithm, when the number of sources is not known.

The signal analyzer 340 may define the 2pth-order cumulant matrix of the kth frequency bin as [Mathematical Expression 7] below, where the signal represents statistical distribution and may include noise signal:

$${K}_{{x}_{k}}^{( ρ )} = {A}_{k}^{( ρ )} {D}_{{s}_{k}}^{( ρ )} + {K}_{{z}_{k}}^{( ρ )} \\ where \\ {K}_{{x}_{k}}^{( ρ )} = [ {κ}_{{x}_{k}}^{( ρ )} [ {n}_{1} ] , {κ}_{{x}_{k}}^{( ρ )} [ {n}_{2} ] , … , {κ}_{{x}_{k}}^{( ρ )} [ {n}_{b} ] ] ( ∈ {{M}^{2 ρ} \times b}^{} ) , \\ {κ}_{{x}_{k}}^{( ρ )} [ n ] = {[ K ( {x}_{k} [ n ] , {g}_{ρ}^{dim ( {x}_{k} [ n ] )} ( 0 ) ) , \\ K ( {x}_{k} [ n ] , {g}_{ρ}^{dim ( {x}_{k} [ n ] )} ( 1 ) ) , … , K ( {x}_{k} [ n ] , {g}_{ρ}^{dim ( {x}_{k} [ n ] )} ( {M}^{2 ρ} - 1 ) ) ]}^{T} ( ∈ {{M}^{2 ρ} \times 1}^{} ) , \\ {D}_{{s}_{k}}^{( ρ )} = [ {d}_{{s}_{k}}^{( ρ )} [ {n}_{1} ] , {d}_{{s}_{k}}^{( ρ )} [ {n}_{2} ] , … , {d}_{{s}_{k}}^{( ρ )} [ {n}_{b} ] ] ( ∈ {I \times b}^{} ) , \\ {d}_{{S}_{k}}^{( ρ )} [ n ] = [ K ( {s}_{k} [ n ] , 0 \cdot {1}_{2 ρ} ) , K ( {s}_{k} [ n ] , 1 \cdot {1}_{2 ρ} ) , … , {K ( {s}_{k} [ n ] , ( I - 1 ) \cdot {1}_{2 ρ} ]}^{T} ( ∈ {I \times 1}^{} ) , \\ {K}_{{z}_{k}}^{( ρ )} = [ {κ}_{{z}_{k}}^{( ρ )} [ {n}_{1} ] , {κ}_{{z}_{k}}^{( ρ )} [ {n}_{2} ] , … , {κ}_{{z}_{k}}^{( ρ )} [ {n}_{b} ] ] ( ∈ {{M}^{2 ρ} \times b}^{} ) , \\ {κ}_{{z}_{k}}^{( ρ )} [ n ] = {[ K ( {z}_{k} [ n ] . {g}_{ρ}^{dim ( {z}_{k} [ n ] )} ( 0 ) ) , K ( {z}_{k} [ n ] , {g}_{ρ}^{dim ( {z}_{k} [ n ] )} ( 1 ) ) , … , K ( {z}_{k} [ n ] , {g}_{ρ}^{dim ( {z}_{k} [ n ] )} ( {M}^{2 ρ} - 1 ) ) ]}^{T} ( ∈ {{M}^{2 ρ} \times 1}^{} ) . \\ {A}_{k}^{( ρ )} = [ {a}_{k}^{( ρ )} ( {θ}_{0} ) , … , {a}_{k}^{( ρ )} ( {θ}_{I - 1} ) ] ( ∈ {{M}^{2 ρ} \times I}^{} ) , \\ {a}_{k}^{( ρ )} ( {θ}_{i} ) = {( {b}_{k} ( {θ}_{i} ) )}^{⊗ ρ} , \\ {b}_{k} ( {θ}_{i} ) = {a}_{k}^{*} ( {θ}_{i} ) ⊗ {a}_{k} ( {θ}_{i} ) \\ and \\ {( u )}^{⊗ ρ} = \underbrace{u ⊗ … ⊗ u}_{ρ - 1 multiplications} . \qquad [ Mathematical expression 7 ]$$

The signal analyzer 340 assumes that the received sensor signals are composed of b stationary segments. For given b stationary segments indexed by set [symbol] ={t|t=1, . . . , b, b≧I+1}, the signal analyzer 340 may determine [symbol] ={nₜ|tε [symbol] } to be the set of starting time markers for all stationary segments, and determine [symbol] ={lₜ|tε [symbol] , lₜ=nₜ₊₁−nₜ} to be the set of segment-lengths for all stationary segments. Here, the signal analyzer 340 may determine that [symbol] (xₖ[nₜ], g_{ρ}^{dim(x}^{ₖ}^{[n}^{ₜ}^{])}^{^{−}}(d)) denotes the local (locally stationary) 2pth-order cumulant indexed by d(0≦d≦M^{2ρ}−1) at the tₜₕ segment. Referring to [Mathematical Expression 7], the signal analyzer 340 may determine that Aₖ^{(ρ)} represents the virtual array manifold matrix of the kth frequency bin; thus the ith column of Aₖ^{(ρ)} and aₖ^{(ρ)} (θᵢ) is the virtual array manifold vector θᵢ at the kth frequency bin and that it is a function of order p.

For stationary Gaussian sensor noises, the signal analyzer 340 may determine that [symbol] (zₖ|[nₜ], g_{ρ}^{dim(z}^{ₖ}^{[n])}(d))=0 ∀nₜ and ∀d when p>1. Then K_{z}_{ₖ}^{(ρ)}=0_{M}_{^{2ρ×b}} where 0_{M}_{^{2ρ×b}}(ε [symbol] ^{M}^{_{2ρ×b}}) is the zero matrix whose elements are all zeros.

The signal analyzer 340 may represent the dimension-reduction procedure of Aₖ^{(ρ)} when p=1, as the product of an orthogonal columns matrix and a Vandermonde matrix, which may be used in the KR subspace-based algorithms. The KR subspace-based algorithms can reduce the complexity of the algorithms according to the embodiments with the dimension-reduction procedure in estimating the DOAs.

The signal analyzer 340 may eliminate K_{z}_{ₖ}^{(ρ)}(K_{z}_{ₖ}^{(ρ)}[n₁]=K_{z}_{ₖ}^{(ρ)}[n₂]= . . . ≦K_{z}_{ₖ}^{(ρ)}[n_{b}]) of [Mathematical Expression 7] with the KR subspace-based algorithms, by projecting Kₓ_{ₖ}^{(ρ)} on to the orthogonal complement projection matrix P as follows:

$$\begin{matrix}{K}_{{x}_{k}}^{( ρ )} P = {A}_{k}^{( ρ )} {D}_{{s}_{k}}^{( ρ )} P + {K}_{{z}_{k}}^{( ρ )} P \\ = {a}_{K}^{( ρ )} {d}_{{S}_{K}}^{( ρ )} p\end{matrix} \qquad [ Mathematical expression 8 ]$$

where P=I_{b}−(1/b)1_{b}1_{b}^{T}, and I_{b} and 1_{b} are b×b identity matrix and b-length column vector whose elements are all ones, respectively. Here, rank(Kₓ_{ₖ}^{(ρ)}) as follows:

$$\begin{matrix} \begin{matrix}rank ( {K}_{{x}_{k}}^{( ρ )} ) = rank ( {A}_{k}^{( ρ )} {D}_{{s}_{k}}^{( ρ )} + {K}_{{z}_{k}}^{( ρ )} ) \\ = rank ( {A}_{k}^{( ρ )} {D}_{{s}_{k}}^{( ρ )} ) + 1 \\ = min ( rank ( {A}_{k}^{( ρ )} ) , rank ( {D}_{{s}_{k}}^{( ρ )} ) ) + 1 \\ = I + 1\end{matrix} & \\ rank ( {K}_{{x}_{k}}^{( ρ )} ) = rank ( {A}_{k}^{( ρ )} {D}_{{s}_{k}}^{( ρ )} P ) = I & [ Mathematical expression 9 ] \\ R ( {K}_{{x}_{k}}^{( ρ )} P ) = R ( {A}_{k}^{( ρ )} {D}_{{s}_{k}}^{( ρ )} P ) = R ( {A}_{k}^{( ρ )} ) & [ Mathematical expression 10 ]\end{matrix}$$

where rank(•) of [Mathematical Expression 9] and R(•) of [Mathematical Expression 10] denote the rank and the range space.

The signal analyzer 340 may multiply Kₓ_{ₖ}^{(ρ)}P, by conjugate transpose of Kₓ_{ₖ}^{(ρ)}P. As a result, the signal analyzer 340 may define the noise-eliminated and dimension-adjusted 2pth-order cumulant matrix as:

$$\begin{matrix}\begin{matrix}{{x}_{k}}_{( ρ )}^{} = {( {K}_{{x}_{k}}^{( ρ )} P ) [ ( {K}_{{x}_{k}}^{( ρ )} P ) ]}^{H} ( ∈ {{M}^{2 ρ} \times {M}^{2 ρ}}^{} ) \\ = {A}_{k}^{( ρ )} ( {D}_{{s}_{k}}^{( ρ )} ) {P ( P )}^{H} {( ( {D}_{{s}_{k}}^{( ρ )} ) )}^{H} {( {A}_{k}^{( ρ )} )}^{H} \\ = {A}_{k}^{( ρ )} {{D}_{{s}_{k}}^{( ρ )} ( {A}_{k}^{( ρ )} )}^{H}\end{matrix} & [ Mathematical expression 11 ] \\ rank ( ( {{x}_{k}}_{( ρ )}^{} ) ) = rank ( {A}_{k}^{( ρ )} {{D}_{{s}_{k}}^{( ρ )} ( {A}_{k}^{( ρ )} )}^{H} ) = I & [ Mathematical expression 12 ] \\ R ( ( {{x}_{k}}_{( ρ )}^{} ) ) = R ( {A}_{k}^{( ρ )} {{D}_{{s}_{k}}^{( ρ )} ( {A}_{k}^{( ρ )} )}^{H} ) = R ( {A}_{k}^{( ρ )} ) & [ Mathematical expression 13 ]\end{matrix}$$

Referring to [Mathematical Expression 11, [symbol] ₛ_{ₖ}^{(ρ)} is not necessarily diagonal, but symmetric and satisfies rank( [symbol] ₛ_{ₖ}^{(ρ)}=I. Therefore, it is possible to represent rank and range of [Mathematical Expression 12] and [Mathematical Expression 13] by applying [Mathematical Expression 11].

The signal analyzer 340 may consider constrained optimization problem (COP) using [symbol] ₓ_{ₖ}^{(ρ)} of [Mathematical Expression 11], where the solution which is a weight vector maximizes the square of the gain in the look direction.

The signal analyzer 340 may constrain the COP by limiting the sum of squares of the inner products between the solution and each of the eigenvectors in R( [symbol] ₓ_{ₖ}^{(ρ)}) referred to as the 2pth-order source-signal subspace and [symbol] ( [symbol] ₓ_{ₖ}^{(ρ)}) referred to as the 2pth-order noise subspace, to a certain constant value. The signal analyzer 340 may represent [symbol] (•) as the null space. The constraint is conditioned on the availability of the number of sources, and the solution according to certain parameter setting in the constraint, can be constrained to span one of three spaces which may be (1) [symbol] ( [symbol] ₛ_{ₖ}^{(ρ)}, (2) [symbol] ( [symbol] ₓ_{ₖ}^{(ρ)}) and (3) both [symbol] ( [symbol] ₓ_{ₖ}^{(ρ)}) and [symbol] ( [symbol] ₓ_{ₖ}^{(ρ)})

The signal analyzer 340 may express the COP as:

$${max}_{{( {w}_{k}^{( ρ )} )}_{θ}} {( {w}_{k}^{( ρ )} )}_{θ}^{H} {a}_{k}^{( ρ )} ( θ ) {( {a}_{k}^{( ρ )} ( θ ) )}^{H} {( {w}_{k}^{( ρ )} )}_{θ} \\ Where , \\ {( {w}_{k}^{( ρ )} )}_{θ , opt} = {{β}_{k}^{( ρ )} ( {B}_{k}^{( ρ )} )}^{- 1} {a}_{k}^{( ρ )} ( θ ) \\ and \\ {β}_{k}^{( p )} = \sqrt{{( {c}_{k}^{( ρ )} )}_{θ} / \{ {( {a}_{k}^{( ρ )} ( θ ) )}^{H} {( {B}_{k}^{( ρ )} )}^{- 1} {a}_{k}^{( ρ )} ( θ ) \}} \qquad [ Mathematical expression 14 ]$$

donate.

subject to

(wₖ^{(ρ)})^{H}Bₖ^{(ρ)}wₖ^{(ρ)}=cₖ^{(ρ)} [Mathematical expression 15]

which may represent the conditions of [Mathematical Expression 14], where

Bₖ^{(ρ)}=U_{s,k}^{(ρ)}(Σ_{s,k}^{(ρ)})(U_{s,k}^{(ρ)})^{H}+αₖ^{(ρ)}I_{M}_{^{2ρ}}, [Mathematical expression 16]

when I is known,

Bₖ^{(ρ)} [symbol] ₓ_{ₖ}^{(ρ)}+αₖ^{(ρ)}I_{M}_{^{2ρ}}, [Mathematical expression 17]

when I is unknown.

Referring to [Mathematical Expression 16] and [Mathematical Expression 17], I_{M}_{^{2ρ}} denotes M^{2ρ}×M^{2ρ} identity matrix.

The signal analyzer 340 may calculate U_{s,k}^{(ρ)}(εζ^{M}^{^{2ρ}}^{×I}) and Σ_{s,k}^{(ρ)}(ε [symbol] ^{I×I}) by the eigenvalue decomposition (EVD) of ζₓ_{ₖ}^{(ρ)} using [Mathematical Expression 16] such that:

$${ℂ}_{{x}_{k}}^{( ρ )} = [ {U}_{s , k}^{( ρ )} {U}_{n , k}^{( ρ )} ] [ \begin{matrix}{Σ}_{s , k}^{( ρ )} & 0 \\ 0 & 0\end{matrix} ] [ \begin{matrix}{( {U}_{s , k}^{( ρ )} )}^{H} \\ {( {U}_{n , k}^{( ρ )} )}^{H}\end{matrix} ]$$

The signal analyzer 340 may compose U_{s,k}^{(ρ)}(εζ^{M}^{^{2ρ}}^{×I}) and U_{n,k}^{(ρ)}(εζ^{M}^{^{2ρ}}^{×(M}^{^{2ρ}}^{-I)}) of the eigenvectors corresponding to the nonzero eigenvalues and zero eigenvalues that span [symbol] (ζₓ_{ₖ}^{(ρ)}) and [symbol] (ζₓ_{ₖ}^{(ρ)}) respectively. The signal analyzer 340 may have Σ_{s,k}^{(ρ)}(ε [symbol] ^{I×I}) which has non-zero values along its diagonal such that Σ_{s,k}^{(ρ)}=diag(σ_{0,k}^{s}, . . . , σ_{I-1,k}^{s}) where σ_{i,k}^{s}>σ_{i+1,k}^{s} for i=0, . . . , I−2. Here, wₖ^{(ρ)}(εζ^{M}^{^{2ρ}}^{×1}) is a weight vector at the kth frequency bin and cₖ^{(ρ)} (>0) is an arbitrary nonzero real constant.

The signal analyzer 340 may so determine that the constraint in [Mathematical Expression 15] is conditioned on the availability of the number of sources. The signal analyzer 340 may represent that Bₖ^{(ρ)} in [Mathematical Expression 16] or [Mathematical Expression 17] is non-singular. The signal analyzer 340 may determine that, in the EVD of Bₖ^{(ρ)}, parameter αₖ^{(ρ)}(>0) determines to the strengths (eigenvalues) associated eigenvectors corresponding to both [symbol] ( [symbol] ₓ_{ₖ}^{(ρ)}) and [symbol] ( [symbol] ₓ_{ₖ}^{(ρ)}). The signal analyzer may thus solve the COP using the Lagrange multiplier λₖ^{(ρ)}. Following [Mathematical Expression 18] may be given as the solution to COP:

$$L ( {λ}_{k}^{( ρ )} , {w}_{k}^{( ρ )} ) = {( {w}_{k}^{( ρ )} )}^{H} {a}_{k}^{( ρ )} ( θ ) {( {a}_{k}^{( ρ )} ( θ ) )}^{H} {w}_{k}^{( ρ )} - {λ}_{k}^{( ρ )} ( {( {w}_{k}^{( ρ )} )}^{H} {B}_{k}^{( ρ )} {w}_{k}^{( ρ )} - {c}_{k}^{( ρ )} ) \qquad [ Mathematical expression 18 ]$$

where λₖ^{(ρ)}>0. When taking the partial derivative of L(λₖ^{(ρ)}, wₖ^{(ρ)}) respect to wₖ^{(ρ)},

$$\frac{\partial L ( {λ}_{k}^{( ρ )} , {w}_{k}^{( ρ )} )}{\partial {w}_{k}^{( ρ )}} = {a}_{k}^{( ρ )} ( θ ) {( {a}_{k}^{( ρ )} ( θ ) )}^{H} {w}_{k}^{( ρ )} - {λ}_{k}^{( ρ )} {B}_{k}^{( ρ )} {w}_{k}^{( ρ )} \qquad [ Mathematical expression 19 ]$$

[Mathematical Expression 19] sets the above gradient to zero, and [Mathematical Expression 19] produces the optimal weight vector (wₖ^{(ρ)})_{θ,opt} which satisfies:

aₖ^{(ρ)}(θ)(aₖ^{(ρ)}(θ))^{H}(wₖ^{(ρ)})_{θ,opt}=λₖ^{(ρ)}Bₖ^{(ρ)}(wₖ^{(ρ)})_{θ,opt} [Mathematical expression 20]

which means (wₖ^{(ρ)})_{θ,opt} is given by the generalized eigenvector associated with the maximum generalized eigenvalue of aₖ^{(ρ)}(θ)(aₖ^{(ρ)}(θ))^{H} and Bₖ^{(ρ)}. Here, k is invertible and [Mathematical Expression 20] can be written in the following form:

(Bₖ^{(ρ)})^{†}aₖ^{(ρ)}(θ)(aₖ^{(ρ)})(θ))^{II}(wₖ^{(ρ)})_{θ,opt}=λₖ^{(ρ)}(wₖ^{(ρ)})_{θ,opt} [Mathematical expression 21]

where (•)^{†} denotes the matrix inverse. For ease explanation, denote

Gₖ^{(ρ)}(θ)=(Bₖ^{(ρ)})^{†}aₖ^{(ρ)}(θ)(aₖ^{(ρ)}(θ))^{H} [Mathematical expression 22]

The signal analyzer 340 may consider two analyses conditioned on the availability of the number of sources for known I and for unknown I (I: number of sources), respectively.

For the analysis of (wₖ^{(ρ)})ₒₚₜ for known I, the signal analyzer 340 may utilize [Mathematical Expression 16].

$$\begin{matrix}{B}_{k}^{( ρ )} = {U}_{s , k}^{( ρ )} ( {\sum }_{s , k}^{( ρ )} ) {( {U}_{s , k}^{( ρ )} )}^{H} + {α}_{k}^{( ρ )} {I}_{{M}^{2 ρ}} \\ = {U}_{s , k}^{( ρ )} [ ( {\sum }_{s , k}^{( ρ )} ) + {α}_{k}^{( ρ )} {I}_{I} ] {( {U}_{s , k}^{( ρ )} )}^{H} + \\ {U}_{n , k}^{( ρ )} {α}_{k}^{( ρ )} {{I}_{{M}^{2 ρ} - I} ( {U}_{n , k}^{( ρ )} )}^{H} .\end{matrix} \qquad [ Mathematical expression 23 ]$$

Given the look direction θ, aₖ^{(ρ)}(θ) may be represented using the eigenvectors of Bₖ^{(ρ)} in [Mathematical Expression 23] as:

$${a}_{k}^{( ρ )} ( θ ) = {\sum }_{i = 0}^{I - 1} {{e}_{i , k}^{s} ( θ ) [ {U}_{s , k}^{( ρ )} ]}_{: , i} + {\sum }_{j = 0}^{{M}^{2 ρ} - I - 1} {{e}_{j , k}^{n} ( θ ) [ {U}_{n , k}^{( ρ )} ]}_{: , j} \qquad [ Mathematical expression 24 ]$$

where e_{i,k}^{s}(θ)=([U_{s,k}^{(ρ)}]_{:,i})^{H}aₖ^{(ρ)}(θ), and e_{j,k}ⁿ(θ)=([U_{n,k}^{(ρ)}]_{:,j})^{H}aₖ^{(ρ)}(θ). Here, [M]_{:,i} denotes the ith column of matrix M. Using [Mathematical Expression 23] and [Mathematical Expression 24], Gₖ^{(ρ)(θ) given as [Mathematical Expression} 22] may be re-written as:

Gₖ^{(ρ)}(θ)=U_{s,k}^{(ρ)}Sₖ(θ)(aₖ^{(ρ)}(θ))^{H}+U_{n,k}^{(ρ)}Nₖ(θ)(aₖ^{(ρ)}(θ))^{H} [Mathematical expression 25]

with the 2pth-order source-signal subspace matrix

$${S}_{k} ( θ ) = diag ( \frac{{e}_{0 , k}^{s} ( θ )}{{σ}_{0 , k}^{s} + {α}_{k}^{( ρ )}} , … , \frac{{e}_{I - 1 , k}^{s} ( θ )}{{σ}_{I - 1 , k}^{s} + {α}_{k}^{( ρ )}} ) \qquad [ Mathematical expression 26 ]$$

and the 2pth-order noise subspace matrix

$${N}_{k} ( θ ) = diag ( \frac{{e}_{0 , k}^{n} ( θ )}{{α}_{k}^{( ρ )}} , … , \frac{{e}_{{M}^{2 ρ} - I - 1 , k}^{s} ( θ )}{{α}_{k}^{( ρ )}} ) . \qquad [ Mathematical expression 27 ]$$

Using Gₖ^{(ρ)}(θ) given as [Mathematical Expression 25], the signal analyzer 340 may derive two separate cases from (wₖ^{(ρ)})ₒₚₜ: when θ=θᵢ and when it is not.

When θ=θᵢ, the signal analyzer 340 may estimate that, from the right-hand side in [Mathematical Expression 24], the second term which spans [symbol] (Aₖ^{(ρ)}) is zero, and (wₖ^{(ρ)})ₒₚₜ is estimated as:

$$\begin{matrix}{( {w}_{k}^{( ρ )} )}_{opt} = arg {max}_{{w}_{k}^{( ρ )}} {( {w}_{k}^{( ρ )} )}^{H} {G}_{k}^{( ρ )} ( θ ) {w}_{k}^{( ρ )} \\ with & [ Mathematical expression 28 ] \\ {G}_{k}^{( ρ )} ( θ ) = {U}_{s , k}^{( ρ )} {\tilde{S}}_{k} ( θ ) {( {U}_{s , k}^{( ρ )} )}^{H} & [ Mathematical expression 29 ]\end{matrix}$$

where

$${\tilde{S}}_{k} ( θ ) = diag ( \frac{{‖ {e}_{0 , k}^{s} ( θ ) ‖}_{2}^{2}}{{σ}_{0 , k}^{s} + {α}_{k}^{( ρ )}} , … , \frac{{‖ {e}_{I - 1 , k}^{s} ( θ ) ‖}_{2}^{2}}{{σ}_{I - 1 , k}^{s} + {α}_{k}^{( ρ )}} ) .$$

Here, ∥•∥₂² denotes the l₂ norm. Therefore, irrespective of αₖ^{(ρ)}, it is possible that span((wₖ^{(ρ)})ₒₚₜ)⊂ [symbol] (Aₖ^{(ρ)}).

When θ=θᵢ, the signal analyzer 340 may estimate (wₖ^{(ρ)})ₒₚₜ using the first and second terms which span [symbol] (Aₖ^{(ρ)}) and [symbol] (Aₖ^{(ρ)}) respectively, from the right-hand side in [Mathematical Expression 24]. The signal analyzer 340 may estimate (wₖ^{(ρ)})ₒₚₜ as:

$${( {w}_{k}^{( ρ )} )}_{opt} = arg {max}_{{w}_{k}^{( ρ )}} {( {w}_{k}^{( ρ )} )}^{H} {G}_{k}^{( ρ )} ( θ ) {( {G}_{k}^{( ρ )} ( θ ) )}^{H} {w}_{k}^{( ρ )} \qquad [ Mathematical expression 30 ]$$

with Gₖ^{(ρ)}(θ) given as [Mathematical Expression 25]. Here, αₖ^{(ρ)} in sₖ(θ) and Nₖ(θ), defined in [Mathematical Expression 26] and [Mathematical Expression 27], may make (wₖ^{(ρ)})ₒₚₜ span either [symbol] (Aₖ^{(ρ)}) or both [symbol] (Aₖ^{(ρ)}) and [symbol] (Aₖ^{(ρ)}), given the look direction θ. Two properties conditioned on the range of αₖ^{(ρ)} are given as follows:

According to the first property, αₖ^{(ρ)} is to achieve high-resolution DOA estimation, in which as αₖ^{(ρ)}<<σ_{i-1,k}and αₖ^{(ρ)}→0 in [Mathematical Expression 25], span ((wₖ^{(ρ)})ₒₚₜ)∩ [symbol] (Aₖ^{(ρ)})→ where is the empty set: each diagonal element value of Nₖ(θ), defined in [Mathematical Expression 27], may become simultaneously larger.

According to the second property, αₖ^{(ρ)} is to achieve the functional equivalence to the 2p-KR-MUSIC such that, as αₖ^{(ρ)}>>σ_{0,k}^{s} and αₖ^{(ρ)}→∞, (wₖ^{(ρ)})ₒₚₜ will be a scaled aₖ^{(ρ)}(θ). Accordingly, all the diagonal elements of sₖ(θ) and Nₖ(θ), defined in [Mathematical Expression 26] and [Mathematical Expression 27], become simultaneously larger.

For the analysis of (wₖ^{(ρ)})_{θ,opt} for unknown I, the signal analyzer 340 may use [Mathematical Expression 17], i.e., use Bₖ^{(ρ)} of [Mathematical Expression 17] to obtain Gₖ^{(ρ)}(θ) given as [Mathematical Expression 25], but U_{s,k}^{(ρ)} and U_{n,k}^{(ρ)} of [Mathematical Expression 25] are unknown. The signal analyzer may derive two separate cases when θ=θᵢ and when it is not, from (wₖ^{(ρ)})_{θ,opt}.

When θ=θᵢ, irrespective of αₖ^{(ρ)}, span((wₖ^{(ρ)})ₒₚₜ)⊂ [symbol] (Aₖ^{(ρ)}) for [Mathematical Expression 28].

When θ≠θᵢ, (wₖ^{(ρ)})_{θ,opt} is given, satisfying [Mathematical Expression 30] with Gₖ^{(ρ)}(θ) given as [Mathematical Expression 25]. Further, the signal analyzer 340 may have two properties conditioned on the range of αₖ^{(ρ)} that make (wₖ^{(ρ)})_{θ,opt} span either [symbol] (Aₖ^{(ρ)}) or both [symbol] (Aₖ^{(ρ)}) and [symbol] (Aₖ^{(ρ)}).

That is, according to the first property, αₖ^{(ρ)} is to achieve high-resolution DOA estimation, in which αₖ^{(ρ)}<σ_{I-1,k}^{s} and αₖ^{(ρ)}→σ_{I-1,k}^{s} in [Mathematical Expression 25], span((wₖ^{(ρ)})ₒₚₜ)∩ [symbol] (Aₖ^{(ρ)})→. Accordingly, each diagonal element value of Sₖ(θ), defined in [Mathematical Expression 26], becomes smaller.

According to the second property, αₖ^{(ρ)} is to achieve the functional equivalence to the 2p-KR-Capon, in which as αₖ^{(ρ)}<<σ_{I-1,k}^{s} and αₖ^{(ρ)}→0, span((wₖ^{(ρ)})ₒₚₜ)∩ [symbol] (Aₖ^{(ρ)})→. Accordingly, each diagonal element value of Nₖ(θ), defined in [Mathematical Expression 27], becomes larger.

The signal analyzer 340 may use different spatial spectra algorithms, depending on whether the number of sources (I) is known or not.

For the known I, the signal analyzer 340 may propose spatial spectrum as [Mathematical Expression 31]. Given (wₖ^{(ρ)})_{θ,opt} in [Mathematical Expression 16] and U_{n,k}^{(ρ)} corresponding to [symbol] ( [symbol] ₓ_{ₓ}^{(ρ)}), the signal analyzer 340 may propose the constrained 2pth-order KR-MUSIC (c-2p-KR-MUSIC) spatial spectrum as follows:

$${P}_{c \text{-} 2 ρ \text{-} KR \text{-} MUSIC} ( θ ) = {( {\sum }_{k}^{ } {‖ {( {( {w}_{k}^{( ρ )} )}_{opt} )}^{H} {U}_{n , k}^{( ρ )} ‖}_{2}^{2} )}^{- 1} \qquad [ Mathematical expression 31 ]$$

When ρ=1 and αₖ^{(ρ)} satisfies αₖ^{(ρ)}>>(σ_{0,k}^{s}) and αₖ^{(ρ)}→∞ with ∥αₖ^{(ρ)}(θ)∥₂²=M^{2ρ, the c-}2-KR-MUSIC is equivalent to the KR-MUSIC without the dimension-reduction procedure such that this can be defined as:

$${P}_{c \text{-} 2 ρ \text{-} KR \text{-} MUSIC} ( θ ) = ( {\sum }_{k}^{ } {‖ {( {( {M}^{2} )}^{- 1} {( {a}_{k}^{( ρ = 1 )} ( θ ) )}^{H} {U}_{n , k}^{( ρ = 1 )} ‖}_{2}^{2} )}^{- 1} \qquad [ Mathematical expression 32 ]$$

For unknown I, the signal analyzer 340 may propose the spatial spectrum as [Mathematical Expression 33]. That is, given (wₖ^{(ρ)})_{θ,opt} in [Mathematical Expression 17] and [symbol] ₓ_{ₖ}^{(ρ)} corresponding to [symbol] ( [symbol] ₓ_{ₖ}^{(ρ)}), the signal analyzer 340 may propose the constrained 2pth-order KR-Capon (c-2p-KR-Capon) spatial spectrum as:

$${P}_{c \text{-} 2 ρ \text{-} KR \text{-} Capon} ( θ ) = {\sum }_{k}^{ } {( {w}_{k}^{( ρ )} )}_{θ , opt}^{H} {{x}_{k}}_{( ρ )}^{} {( {w}_{k}^{( ρ )} )}_{θ , opt} \qquad [ Mathematical expression 33 ]$$

When ρ=1 and αₖ^{(ρ)}<<σ_{I-1,k}^{s} and αₖ^{(ρ)}→0, the c-2-KR-Capon is equivalent to the KR-Capon without the dimension-reduction procedure such that:

$${P}_{c \text{-} 2 \text{-} KR \text{-} Capon} ( θ ) = {\sum }_{k}^{ } {( {w}_{k}^{( ρ = 1 )} )}_{θ , opt}^{H} {{x}_{k}}_{( ρ = 1 )}^{} {( {w}_{k}^{( ρ = 1 )} )}_{θ , opt} \qquad [ Mathematical expression 34 ]$$

For the c-2p-KR-MUSIC and c-2p-KR-Capon, the signal analyzer 340 may provide (wₖ^{(ρ)})_{θ,opt} as the solution to [Mathematical Expression 21], as the non-singular vector corresponding to the largest non-singular value of Gₖ^{(ρ)}(θ) by the singular value decomposition (SVD). By searching the look direction, θ, the signal analyzer 340 may calculate the DOAs as the local peaks of the proposed C-2P-KR-MUSIC and C-2P-KR-Capon.

The direction estimator 360 may estimate the DOAs using the data of the signals as analyzed at the signal analyzer 340. The direction estimator 360 may estimate the DOA of the source signal based on the look direction of non-singular vector with the largest non-singular value as calculated by the SVD.

In practice, it is not easy for the direction estimator 360 to determine αₖ^{(ρ)} since [symbol] ₓ_{ₖ}^{(ρ)} is not available and its estimate will have certain error such that [Mathematical Expression 13] is not satisfied. In other words, denote [symbol] ₓ_{ₖ}^{(ρ)} as the estimate of [symbol] ₓ_{ₖ}^{(ρ)}, then [symbol] ( [symbol] ₓ_{ₖ}^{(ρ)})≠ [symbol] (Aₖ^{(ρ)}) and [symbol] ( [symbol] ₓ_{ₖ}^{(ρ)})≠ [symbol] (Aₖ^{(ρ)}). Considering the error of [symbol] ₓ_{ₖ}^{(ρ)}, αₖ^{(ρ)} is determined to balance the high-resolution DOA estimation and the functional equivalence to the 2p-KR-MUSIC and 2p-KR-Capon.

For the c-2p-KR-MUSIC and based on the above two conditions (when θ≠θᵢ), the direction estimator 360 may set αₖ^{(ρ)} to be proportional to the maximum eigenvalue of [symbol] ₓ_{ₖ}^{(ρ)} as:

αₖ^{(ρ)}=ξₖ×\hat{σ}_{0,k}^{s}≧\hat{σ}_{0,k}^{s}, ξₖ≧1 [Mathematical expression 35]

For the c-2p-KR-Capon and based on the above two conditions (when θ≠θᵢ), the direction estimator 360 may set αₖ^{(ρ)} to be proportional to the non-zero minimum eigenvalue of [symbol] ₓ_{ₖ}^{(ρ)} as:

αₖ^{(ρ)}=δₖ×σ_{J,k}^{s}, 0<δₖ≦1 [Mathematical expression 36]

where J=2ρ(M−1)+1 which is the maximum rank of [symbol] ₓ_{ₖ}^{(ρ)} can take.

The direction estimator 360 may calculate time average using [symbol] and [symbol] ₓ_{ₖ}^{(ρ)} as given in [Mathematical Expression 11]. However, for the non-stationary source signals such as audio, [symbol] is unknown and impossible to determine. A fixed value lₜ and ∀ₜ may not lead to accurate DOA estimation. For this reason, the direction estimator 360 may obtain the estimate of [symbol] ₓ_{ₖ}^{(ρ)} by marginalizing over all possible [symbol] ₛ as:

E_{L}( [symbol] ₓ_{ₖ}^{(ρ)}| [symbol] ) [Mathematical expression 37]

where lₜ˜p(lₜ) and [symbol] ₓ_{ₖ}^{(ρ)} is the time-average of [symbol] ₓ_{ₖ}^{(ρ)} given [symbol] . Instead of using [symbol] ₓ_{ₖ}^{(ρ)}, [Mathematical Expression 37] may be considered in the COP to enhance the accuracy of the DOA, giving an average (wₖ^{(ρ)})ₒₚₜ.

The controller 240 calculates a set of real sensor locations in aₖ(θ), defined in [Mathematical Expression 4], as Sᵣ={m×dₛ|m=0, . . . , M−1} with dₛ distance and, a set of real and virtual sensor locations in aₖ^{(ρ)}(θ) in [Mathematical Expression 7] as:

Sᵥ^{(ρ)}={mᵥ×dₛ|mᵥ=−ρ(M−1), . . . , −1,0,1, . . . , ρ(M−1)} [Mathematical expression 38]

That is, the controller 240 may use the coordinates of the virtual sensors of order p considering only the space diversity from the view point of the virtual array framework or co-array framework. The number of real and virtual sensors in [Mathematical Expression 38] is 2p(M−1)+1 and therefore, the controller 240 may produce the identifiability of the C-2p-KR-MUSIC, which is a function of order p and M as:

I(ρ,M)≦2p(M−1). [Mathematical expression 39]

It is identical to that of the c-2p-KR-MUSIC and a generalization in identifiability of the KR-MUSIC.

In conclusion, the controller 240 may drive and operate in the following order.

At Step 1, the controller 240 may calculate [symbol] ₓ_{ₖ}^{(ρ)} or E [symbol] ( [symbol] ₓ_{ₖ}^{(ρ)}| [symbol] ) using [Mathematical Expression 37].

At Step 2, the controller may calculate look direction θ, using [Mathematical Expression 22], by calculating non-singular vector (wₖ^{(ρ)})_{θ,opt}, which is the largest non-singular value as calculated with Gₖ^{(ρ)}(θ) by SVD, with P_{c-2ρ-KR-MUSIC}(θ) in [Mathematical Expression 31] or P_{c-2ρ-KR-Capon}(θ), in [Mathematical Expression 33]. For known I, the controller 240 may calculate Bₖ^{(ρ)} using [Mathematical Expression 16], and calculate αₖ^{(ρ)} using [Mathematical Expression 35]. For unknown I, the controller 240 may calculate Bₖ^{(ρ)} using [Mathematical Expression 17], and calculate αₖ^{(ρ)} using [Mathematical Expression 36].

At Step 3, the controller 240 estimate the direction that corresponds to the local peaks of the spatial spectrum as proposed.

The controller 240 may propose the following algorithms when ρ=1,2. The c-2p-KR-MUSIC and c-2-KR-Capon algorithms may be those that are derived from COP using [symbol] ₓ_{ₖ}^{(ρ=1)}. The c-2-KR-MUSIC-M and c-2-KR-Capon-M algorithms may be c-2p-KR-MUSIC and 2p-KR-Capon algorithms using E_{L}( [symbol] ₓ_{ₖ}^{(ρ=1)}| [symbol] ). The 4-KR-MUSIC and 4-KR-Capon algorithms may be KR-MUSIC and KR-Capon algorithms which are simply extended using [symbol] ₓ_{ₖ}^{(ρ=2)}. The c-4-KR-MUSIC and c-4-KR-Capon may be the algorithms derived from COP using [symbol] ₓ_{ₖ}^{(ρ=2)}. The c-4-KR-MUSIC-M and c-4-KR-Capon-M may be c-4-KR-MUSIC and c-4-KR-Capon algorithm using E [symbol] ( [symbol] ₓ_{ₖ}^{(ρ=2)}| [symbol] ).

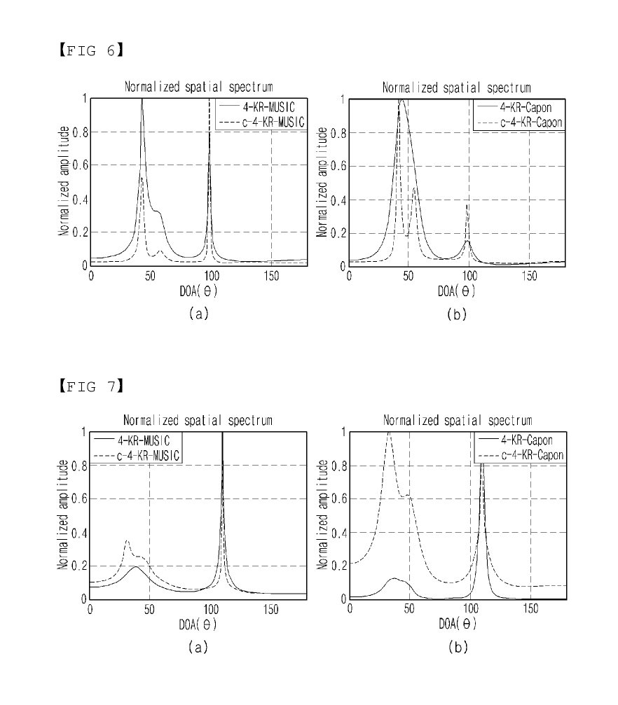

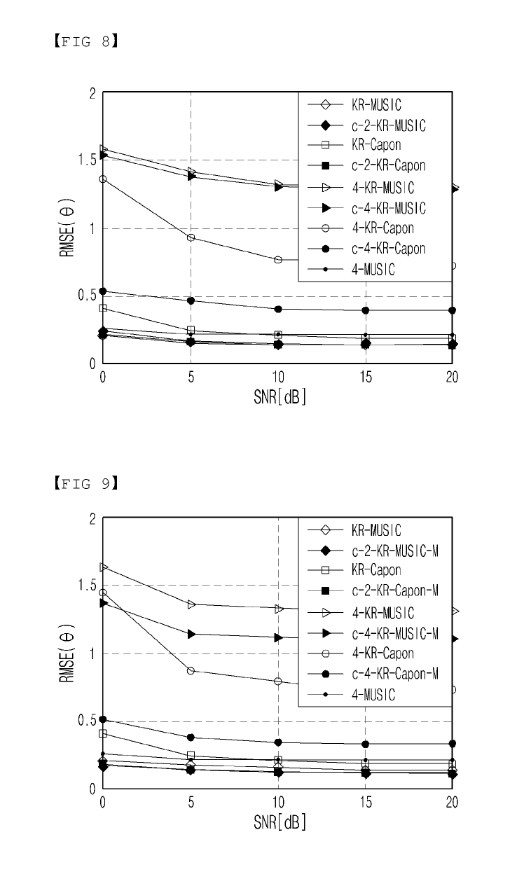

FIG. 4 is the graphical representation of high-resolution capability of the DOA estimation device according to an embodiment. FIG. 5 is a graphical representation of high-resolution capability of a DOA estimation device according to another embodiment, FIG. 6 is a graphical representation of high-resolution capability of a DOA estimation device according to yet another embodiment, and FIG. 7 is a graphical representation of high-resolution capability of a DOA estimation device according to yet another embodiment.

Referring to FIGS. 4 to 7, the DOA estimation device 1 can have high aptial resolution capability.

The graphs in FIG. 4 particularly represent the wide-band non-stationary source signals generated in the generalized Gaussian distribution. FIG. 4 shows spatial spectra of KR-Capon, c-2-KR-Capon, 4-KR-Capon and c-4-KR-Capon. FIG. 4 shows the graphs when (M,I)=(2,2), θ0=40°, θ₁=42° and SNR=20 db.

FIG. 4(a) shows the comparison between KR-Capon and c-2-KR-Capon. FIG. 4(a) indicates that the c-2-KR-Capon has higher spatial resolution capability than KR-Capon. The deeper curve of the spatial spectra of c-2-KR-Capon than those of KR-Capon indicates clearer distinction between θ₀ and θ₁ and thus indicates that the former can produce higher spatial resolution than the latter.

FIG. 4(b) shows the graphs for comparison between 4-KR-Capon and c-4-KR-Capon. FIG. 4(b) shows that c-4-KR-Capon produces better spatial resolution than 4-KR-Capon. The deeper curve of the spatial spectra of c-4-KR-Capon than those of 4-KR-Capon indicates clearer distinction between θ₀ and θ₁ and thus indicates that the former can produce higher spatial resolution than the latter.

The graphs in FIG. 5 particularly represent the narrow-band non-stationary source signals generated in the generalized Gaussian distribution. FIG. 5 shows spatial spectra of KR-MUSIC, c-2-KR-MUSIC, 4-KR-MUSIC and c-4-KR-MUSIC. FIG. 5 shows the graphs when (M,I)=(2,2), θ₀=40°, θ₁=42° and SNR=15 dB.

FIG. 5(a) shows the comparison between KR-MUSIC and c-2-KR-MUSIC. FIG. 5(a) indicates that the c-2-KR-MUSIC has higher spatial resolution capability than KR-MUSIC. The deeper curve of the spatial spectra of c-2-KR-MUSIC than those of KR-MUSIC indicates clearer distinction between θ₀ and θ₁ and thus indicates that the former can produce higher spatial resolution than the latter.

FIG. 5(b) shows the comparison between 4-KR-MUSIC and c-4-KR-MUSIC. FIG. 5(b) indicates that the c-4-KR-MUSIC has higher spatial resolution capability than 4-KR-MUSIC. The deeper curve of the spatial spectra of c-4-KR-MUSIC than those of 4-KR-MUSIC indicates clearer distinction between θ₀ and θ₁ and thus indicates that the former can produce higher spatial resolution than the latter.

The graphs in FIG. 6 particularly represent the narrow-band non-stationary source signals generated in the generalized Gaussian distribution. FIG. 6 shows spatial spectra of 4-KR-MUSIC, c-4-KR-MUSIC, 4-KR-Capon and c-4-KR-=Capon. FIG. 6 shows the graphs when (M,I)=(2, 3) θ₀=40°, θ₁=55°, θ₂=100° and SNR=20 dB.

FIG. 6(a) shows the comparison between 4-KR-MUSIC and c-4-KR-MUSIC. FIG. 6(a) indicates that the c-4-KR-MUSIC has higher spatial resolution capability than 4-KR-MUSIC. The deeper curve of the spatial spectra of c-4-KR-MUSIC than those of 4-KR-MUSIC indicates clearer distinction among θ₀, θ₁ and θ₂ and thus indicates that the former can produce higher spatial resolution than the latter.

FIG. 6(b) shows the comparison between 4-KR-Capon and c-4-KR-Capon. FIG. 6(b) indicates that the c-4-KR-Capon has higher spatial resolution capability than the 4-KR-Capon. The deeper curve of the spatial spectra of c-4-KR-Capon than those of 4-KR-Capon indicates clearer distinction among θ₀, θ₁ and θ₂ and thus indicates that the former can produce higher spatial resolution than the latter.

FIG. 7 shows graphs of speech and audio signals which are the wide-band non-stationary source signals. FIG. 7 shows spatial spectra of 4-KR-MUSIC, c-4-KR-MUSIC, 4-KR-Capon and c-4-KR-Capon, when (M,I)=(2,3), θ₀=30°, θ₁=50 °, θ₂=110° and SNR=25 dB.

FIG. 7(a) shows comparison between 4-KR-MUSIC and c-4-KR-MUSIC. FIG. 7(a) shows that the c-4-KR-MUSIC produces better spatial resolution than the 4-KR-MUSIC. The clearer curve of the spatial spectra of the c-4-KR-MUSIC at a corresponding look direction than that of the spatial spectra of the 4-KR-MUSIC indicates clearer distinction among θ₀, θ₁ and θ₂ and thus indicates better spatial resolution capability of the former than the latter.

FIG. 7(b) shows comparison between 4-KR-Capon and c-4-KR-Capon. FIG. 7(b) shows that the c-4-KR-Capon produces better spatial resolution than the 4-KR-Capon. The clearer curve of the spatial spectra of the c-4-KR-Capon at a corresponding look direction than that of the spatial spectra of the 4-KR-Capon indicates clearer distinction among θ₀, θ₁ and θ₂ and thus indicates better spatial resolution capability of the former than the latter.

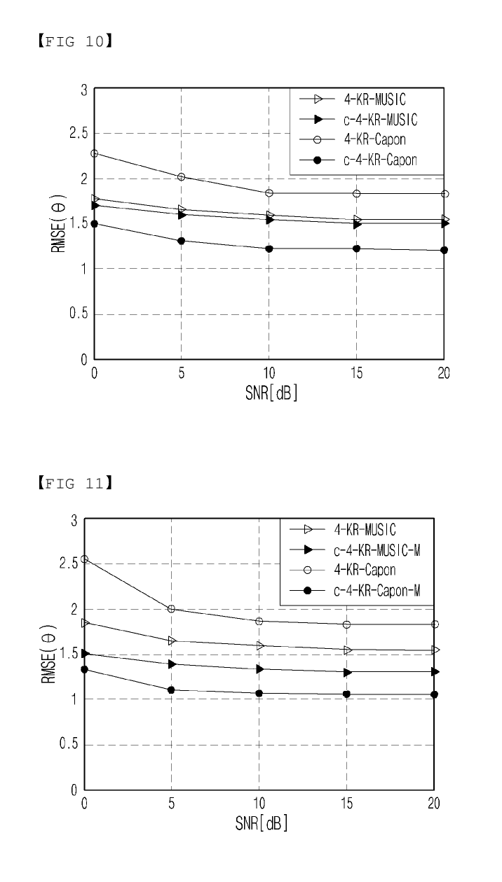

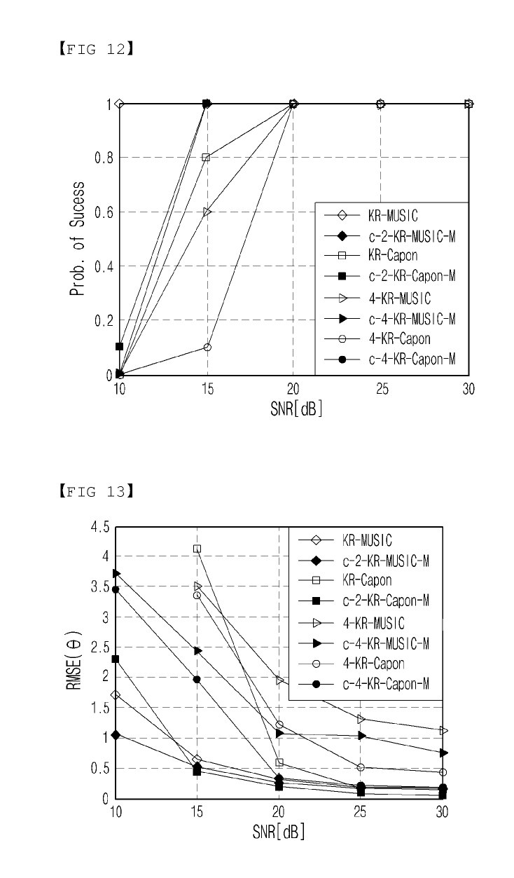

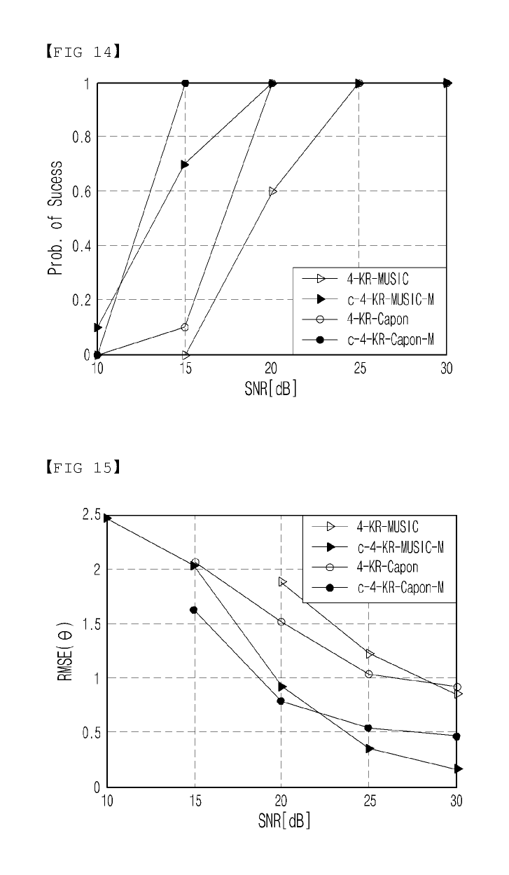

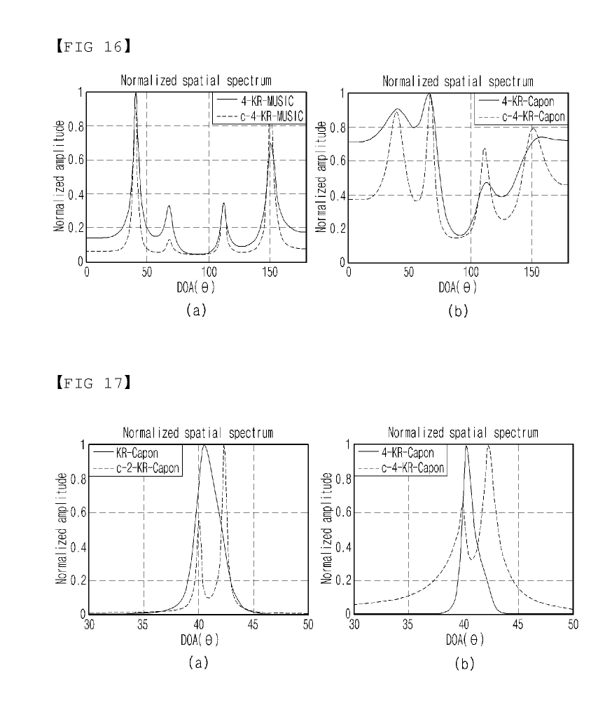

FIG. 8 is a graphical representation of high accuracy of a DOA estimation device according to an embodiment, FIG. 9 is a graphical representation of high accuracy of a DOA estimation device according to another embodiment, FIG. 10 is a graphical representation of high accuracy of a DOA estimation device according to yet another embodiment, FIG. 11 is a graphical representation of high accuracy of a DOA estimation device according to yet another embodiment, FIG. 12 is a graphical representation of high accuracy of a DOA estimation device according to yet another embodiment, FIG. 13 is a graphical representation of high accuracy of a DOA estimation device according to yet another embodiment, FIG. 14 is a graphical representation of high accuracy of a DOA estimation device according to yet another embodiment, and FIG. 15 is a graphical representation of high accuracy of a DOA estimation device according to yet another embodiment.

Referring to FIGS. 8 to 15, the DOA estimation device 1 may have high probability of success (PoS) and low root-mean-sqquard-angle error (RMSE).

FIG. 8 shows graphs of narrow-band non-stationary source signals generated in normalized Gaussian distribution. FIG. 8 shows RMSE of signal to noise ratio (SNR) of the KR-MUSIC, c-2-KR-MUSIC, KR-Capon, c-2-KR-Capon, 4-KR-MUSIC, c-4-KR-MUSIC, 4-KR-Capon, c-4-KR-Capon and 4-C MUSIC, when (M,I)=(2,2), θ₀=40°, θ₁=70° and PoS=1.

FIG. 8 shows that c-2-KR-MUSIC, c-2-KR-Capon, c-4-KR-MUSIC and c-4-KR-Capon, corresponding to KR-MUSIC, KR-Capon, 4-KR-MUSIC and 4-KR-Capon, have low RMSE. This means that the c-2-KR-MUSIC, c-2-KR-Capon, c-4-KR-MUSIC and c-4-KR-Capon have less error than the KR-MUSIC, KR-Capon, 4-KR-MUSIC and 4-KR-Capon.

FIG. 9 shows graphs of narrow-band non-stationary source signals generated in normalized Gaussian distribution. FIG. 9 shows RMSE of signal to noise ratio (SNR) of the KR-MUSIC, c-2-KR-MUSIC-M, KR-Capon, c-2-KR-Capon-M, 4-KR-MUSIC, c-4-KR-MUSIC-M, 4-KR-Capon, c-4-KR-Capon-M and 4-MUSIC, when (M,I)=(2,2), θ₀=40°, θ₁=70° and PoS=1.

FIG. 9 shows that c-2-KR-MUSIC-M, c-2-KR-Capon-M, c-4-KR-MUSIC-M and c-4-KR-Capon-M, corresponding to KR-MUSIC, KR-Capon, 4-KR-MUSIC and 4-KR-Capon, have low RMSE. This means that the c-2-KR-MUSIC-M, c-2-KR-Capon-M, c-4-KR-MUSIC-M and c-4-KR-Capon-M have less error than the KR-MUSIC, KR-Capon, 4-KR-MUSIC and 4-KR-Capon. FIG. 9 also shows that, using [symbol] ( [symbol] ₓ_{ₖ}^{(ρ)} [symbol] ) in [Mathematical Expression 37] increases the RMSE margins between the dashed lines and the solid lines. The above comparison shows that [symbol] ( [symbol] ₓ_{ₖ}^{(ρ)} [symbol] ) is indeed effective in providing more accurate DOAs.

FIG. 10 shows graphs of narrow-band non-stationary source signals generated in normalized Gaussian distribution. FIG. 10 shows RMSE of signal to noise ratio (SNR) of the 4-KR-MUSIC, c-4-KR-MUSIC, 4-KR-Capon and c-4-KR-Capon, when (M,I)=(2,3), θ₀=40°, θ₁=70°, θ₂=100° and PoS=1.

FIG. 10 shows that c-4-KR-MUSIC and c-4-KR-Capon, corresponding to 4-KR-MUSIC and 4-KR-Capon, have low RMSE. This means that the c-4-KR-MUSIC and c-4-KR-Capon have less error than the 4-KR-MUSIC and 4-KR-Capon.

FIG. 11 shows graphs of narrow-band non-stationary source signals generated in normalized Gaussian distribution. FIG. 11 shows RMSE of signal to noise ratio (SNR) of the 4-KR-MUSIC, c-4-KR-MUSIC-M, 4-KR-Capon and c-4-KR-Capon-M, when (M,I)=(2,3), θ₀=40°, θ₁=70°, θ₂=100° and PoS=1.

FIG. 11 shows that c-4-KR-MUSIC-M and c-4-KR-Capon-M, corresponding to 4-KR-MUSIC and 4-KR-Capon, have low RMSE. This means that the c-4-KR-MUSIC and c-4-KR-Capon have less error than the 4-KR-MUSIC and 4-KR-Capon. FIG. 11 also shows that, using [symbol] ( [symbol] ₓ_{ₖ}^{(ρ)} [symbol] ) increases the RMSE margins between the dashed lines and the solid lines. The above comparison shows that [symbol] ( [symbol] ₓ_{ₖ}^{(ρ)} [symbol] ) is indeed effective in providing more accurate DOAs.

FIG. 12 shows graphs of speech and audio signals which are the wide-band non-stationary source signals. FIG. 11 shows PoS versus SNR for the KR-MUSIC, c-2-KR-MUSIC-M, KR-Capon, c-2-KR-Capon-M, 4-KR-MUSIC, c-4-KR-MUSIC-M, 4-KR-Capon and c-4-KR-Capon-M, when (M,I)=(2,2), θ₀=30° and θ₁=70°.

FIG. 12 demonstrates that the c-2p-KR-MUSIC-M and c-2p-Capon-M when p=1 have higher PoS than the 2p-KR-MUSIC and 2p-KR-Capon. FIG. 12 shows that PoS is particularly high with low SNR and p=2.

FIG. 13 shows graphs of speech and audio signals which are the wide-band non-stationary source signals. FIG. 13 shows RMSE versus SNR for the KR-MUSIC, c-2-KR-MUSIC-M, KR-Capon, c-2-KR-Capon-M, 4-KR-MUSIC, c-4-KR-MUSIC-M, 4-KR-Capon and c-4-KR-Capon-M, when (M,I)=(2,2), θ₀=30°, θ₁=70° and PoS=O.

FIG. 13 demonstrates that the c-2p-KR-MUSIC-M and c-2p-Capon-M when p=1, 2 have better result than the 2p-KR-MUSIC and 2p-KR-Capon.

FIG. 14 shows graphs of speech and audio signals which are the wide-band non-stationary source signals. FIG. 14 shows PoS versus SNR for the 4-KR-MUSIC, c-4-KR-MUSIC-M, 4-KR-Capon and c-4-KR-Capon-M, when (M,I)=(2,3), θ₀=40°, θ₁=70° and θ₂=100°.

FIG. 14 demonstrates that c-4-KR-MUSIC-M and c-4-KR-Capon-M have higher PoS than the 4-KR-MUSIC and 4-KR-Capon. FIG. 14 shows that PoS is particularly high with low SNR.

FIG. 15 shows graphs of speech and audio signals which are the wide-band non-stationary source signals. FIG. 15 shows RMSE versus SNR for the 4-KR-MUSIC, c-4-KR-MUSIC-M, 4-KR-Capon and c-4-KR-Capon-M, when (M,I)=(2,3), θ₀=40°, θ₁=70° and θ₂=100°.

FIG. 15 demonstrates that the c-4-KR-MUSIC-M and c-4-KR-Capon-M have higher PoS than the 4-KR-MUSIC and 4-KR-Capon. FIG. 15 shows that PoS is particularly high with low SNR.

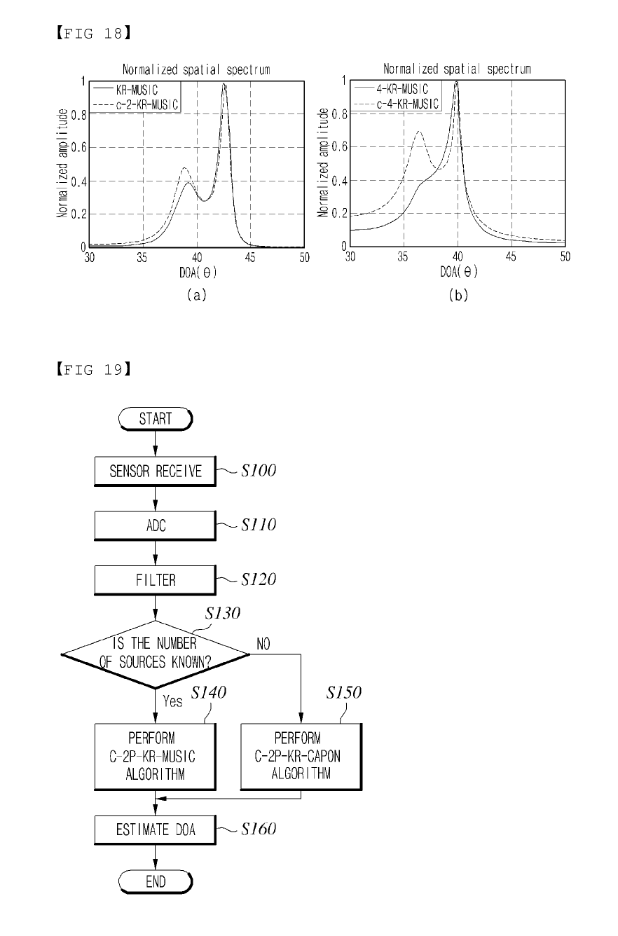

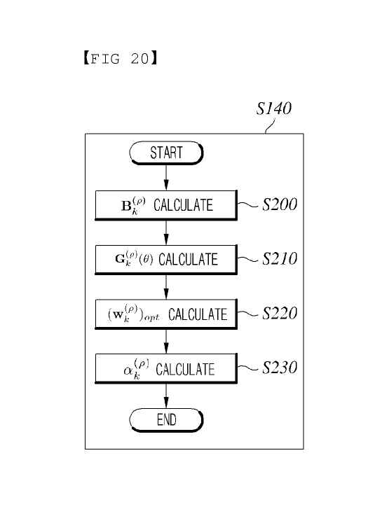

FIG. 16 is a graphical representation showing the number of retrieved sound sources by a DOA estimation device according to an embodiment, FIG. 17 is a graphical representation showing the number of retrieved sound sources by a DOA estimation device according to another embodiment, and FIG. 18 is a graphical representation showing the number of retrieved sound sources by a DOA estimation device according to yet another embodiment.

Referring to FIGS. 16 to 18, the DOA estimation device 1 may retrieve more number of source signals.

FIG. 16 shows the graphs of narrow-band non-stationary source signals generated in normalized Gaussian distribution. FIG. 16 shows retrieval of the number of source signals with 4-KR-MUSIC, c-4-KR-MUSIC, 4-KR-Capon and c-4-KR-Capon, when (M,I)=(2,3), θ₀=40°, θ₁=70°, θ₂=100°, θ₃=150° and SNR=20 dB.

FIG. 16(a) shows comparison between the 4-KR-MUSIC and the c-4-KR-MUSIC. FIG. 16(a) shows four peaks of the c-4-KR-MUSIC more explicitly than four peaks of the 4-KR-MUSIC. Accordingly, FIG. 16(a) demonstrates that the c-4-KR-MUSIC can retrieve more source signals than the 4-KR-MUSIC.

FIG. 16(b) shows graphs for comparison between the 4-KR-Capon and the c-4-KR-Capon. FIG. 16(b) shows four peaks of the c-4-KR-Capon more explicitly than four peaks of the 4-KR-Capon. Accordingly, FIG. 16(b) demonstrates that the c-4-KR-Capon can retrieve more source signals than the 4-KR-Capon.

FIG. 17 shows the graphs of wide-band non-stationary source signals generated in normalized Gaussian distribution. FIG. 17 shows retrieval of the number of source signals with KR-Capon, c-2-KR-Capon, 4-KR-Capon and c-4-KR-Capon, when (M,I) (2,2), θ₀=30°, θ₁=35° and SNR=340 dB.

FIG. 17(a) shows comparison between the KR-Capon and the c-2-KR-Capon. FIG. 17(a) shows that while the DOA estimation device 1 retrieves two peaks using the c-2-KR-Capon, it retrieves only one peak when using the KR-Capon. Accordingly, FIG. 17(a) demonstrates that the c-2-KR-Capon can retrieve more source signals than the KR-Capon.

FIG. 17(b) shows comparison between the 4-KR-Capon [symbol] c-4-KR-Capon. FIG. 17(b) shows that while the DOA estimation device 1 retrieves two peaks using the c-4-KR-Capon, it retrieves only one peak when using the 4-KR-Capon. Accordingly, FIG. 17(b) demonstrates that the c-4-KR-Capon can retrieve more source signals than the 4-KR-Capon.

FIG. 18 shows the graphs of speech and audio signals which are the wide-band non-stationary source signals. FIG. 18 shows retrieval of the number of source signals with KR-MUSIC, c-2-KR-MUSIC, 4-KR-MUSIC and c-4-KR-MUSIC, when (M,I)=(2,2), θ₀=30°, θ₁=45° and SNR=30 dB (FIG. 18(a)) and when (M,I)=(2,2), θ₀=30°, θ₁=50° and SNR=25 dB (FIG. 18(b)).

FIG. 18(a) shows comparison between the KR-MUSIC and the c-2-KR-MUSIC. FIG. 18(a) shows the two peaks of the c-4-KR-MUSIC more explicitly than the two peaks of the c-4-KR-MUSIC. Accordingly, FIG. 18(a) demonstrates that the c-4-KR-MUSIC can retrieve more source signals than the 4-KR-MUSIC.

FIG. 18(b) shows comparison between the 4-KR-MUSIC and the c-4-KR-MUSIC. FIG. 18(b) shows the two peaks of the c-4-KR-MUSIC more explicitly than the two peaks of the 4-KR-MUSIC. Accordingly, FIG. 18(b) demonstrates that the c-4-KR-MUSIC can retrieve more source signals than the 4-KR-MUSIC.

FIG. 19 is a flowchart provided to explain a DOA estimation method according to an embodiment.

Referring to FIG. 19, the DOA estimation device 1 may be configured to estimate the DOA by analyzing the signals of the source.

At S100, the sensor unit 220 detects signals. The detected signals may include at least one of source signals outputted from the source and noise signal. The source signal may be non-stationary, and the noise signal may be stationary.

The sensor unit 220 may detect signals outputted from sources 110, 120, 130, 140, and analyze the detected signal. The sensor unit 220 may have less number of sensors than the sources.

At S110, the pre-processor 320 performs ADC in which the pre-processor 320 converts the signal in analogue form into digital sensor signal. The pre-processor 320 may sample the signals and convert the same into sensor signal which is digital.

At S120, the signal analyzer 340 filters out noise signal entrained in the converted sensor signal. The signal analyzer 340 may calculate statistical distribution data of the signal converted at the pre-processor 320. The signal analyzer 340 may retrieve only the statistical distribution data of the source signal which is removed of the noise signal (stationary) and which is non-stationary. The signal analyzer 340 may include at least one of a low pass filter and band pass filter.

At S130, the signal analyzer 340 determines whether the number of sources is know or not known. The signal analyzer 340 may determine whether the number of sources is known or not, and use different algorithms depending on whether the number of sources is known or not known.

For the known number of sources, at S140, the signal analyzer 340 performs c-2p-KR-MUSIC algorithm. The signal analyzer 340 may calculate non-singular value using MUSIC algorithm-based c-2p-KR-MUSIC algorithm.

For the unknown number of sources, at S150, the signal analyzer 340 performs the c-2p-KR-Capon algorithm. The signal analyzer 340 may calculate non-singular value using the Capon algorithm-based c-2p-KR-Capon algorithm.

At S160, the direction estimator 360 estimates DOA using the non-singular value as calculated. The direction estimator 360 may estimate the DOA based on the source signal that corresponds to the largest non-singular value as calculated at S140 and S150.

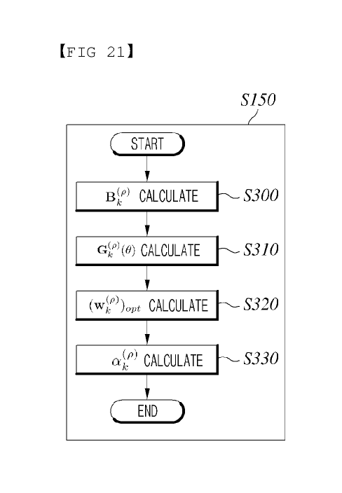

FIG. 20 is a flowchart provided to explain operation at S140 of FIG. 19 in detail.

Referring to FIG. 20, the signal analyzer 340 may perform c-2p-KR-MUSIC algorithm for the known number of sources.

At S200, the signal analyzer 340 calculates Bₖ^{(ρ)}. The signal analyzer 340 may calculate non-singular matrix Bₖ^{(ρ)} using [Mathematical Expression 16a].

At S210, the signal analyzer 340 calculates Gₖ^{(ρ)}(θ). The signal analyzer 340 may calculate Lagrange multiplier Gₖ^{(ρ)}(θ) using [Mathematical Expression 22]. The signal analyzer 340 may calculate Gₖ^{(ρ)}(θ) using Bₖ^{(ρ)} calculated at S200.

At S220, the signal analyzer 340 calculates (wₖ^{(ρ)})ₒₚₜ. The signal analyzer 340 may calculate optimum weight vector (wₖ^{(ρ)})ₒₚₜ using [Mathematical Expression 28] or [Mathematical Expression 29]. The signal analyzer 340 may calculate (wₖ^{(ρ)})ₒₚₜ using Gₖ^{(ρ)}(θ) calculated at S210.

At S230, the signal analyzer 340 calculates αₖ^{(ρ)}. Using [Mathematical Expression 35], the signal analyzer 340 calculates eigenvectors αₖ^{(ρ)} associated with eigenvalues that correspond to both eigenvector [symbol] ( [symbol] ₓ_{ₖ}^{(ρ)}) representing source signal and eigenvalues that correspond to eigenvector [symbol] ( [symbol] ₓ_{ₖ}^{(ρ)}) representing noise signal. The signal analyzer 340 can calculate αₖ^{(ρ)} using (wₖ^{(ρ)})ₒₚₜ calculated at S220.

FIG. 21 is a flowchart provided to explain in detail operation at S150 of FIG. 19.

Referring to FIG. 21, the signal analyzer 340 may perform c-2p-KR-Capon algorithm for known number of sources.

At S300, the signal analyzer 340 calculates Bₖ^{(ρ)}. The signal analyzer 340 may calculate non-singular matrix Bₖ^{(ρ)} using [Mathematical Expression 16b].

At S310, the signal analyzer 340 calculates Gₖ^{(ρ)}(θ). The signal analyzer 340 may calculate Lagrange multiplier Gₖ^{(ρ)}(θ) using [Mathematical Expression 22]. The signal analyzer 340 may calculate Gₖ^{(ρ)}(θ) using Bₖ^{(ρ)} calculated at S300.

At S320, the signal analyzer 340 calculates (wₖ^{(ρ)})ₒₚₜ. The signal analyzer 340 may calculate optimum weight vector) (wₖ^{(ρ)})ₒₚₜ using [Mathematical Expression 28] or [Mathematical Expression 29]. The signal analyzer 340 may calculate (wₖ^{(ρ)})ₒₚₜ using Gₖ^{(ρ)}(θ) calculated at S310.

At S330, the signal analyzer 340 calculates αₖ^{(ρ)}. Using [Mathematical Expression 36], the signal analyzer 340 calculates eigenvectors αₖ^{(ρ)} associated with eigenvalues that correspond to both eigenvector [symbol] ( [symbol] ₓ_{ₖ}^{(ρ)}) representing source signal and eigenvalues that correspond to eigenvector [symbol] ( [symbol] ₓ_{ₖ}^{(ρ)}) representing noise signal. The signal analyzer 340 can calculate αₖ^{(ρ)} using (wₖ^{(ρ)})ₒₚₜ calculated at S320.

The embodiments of the present invention are implementable in the form of computer-readable codes on a computer-readable recording medium. The ‘computer-readable recording medium’ encompasses all types of recording devices that store data for reading by a computing device. An example of the computer-readable recording medium may include ROM, RAM, CD-ROM, magnetic tape, floppy disk, or optical data storage device, or may include a carrier wave (e.g., transmission via the Internet) form. Further, the computer-readable recording medium may be distributed to computing devices networked with each other, and store and execute computer-readable codes in distributed manner.

The foregoing exemplary embodiments and advantages are merely exemplary and are not to be construed as limiting the present invention. The present teaching can be readily applied to other types of apparatuses. Also, the description of the exemplary embodiments of the present inventive concept is intended to be illustrative, and not to limit the scope of the claims.

1-12. (canceled)

13. A direction of arrival (DOA) estimation device, comprising:
a sensor unit configured to detect a signal and comprising two or more sensors to output sensor signals as a detect signal in response to the detected signal; and
a controller configured to calculate statistical distribution data indicative of statistical distribution of each of the sensor signals outputted from the two or more sensors, respectively, retrieve statistical distribution data indicative of statistical distribution of a source signal which is a non-stationary signal entrained in the signal of the calculated statistical distribution data, and estimate DOA of the source signal based on the retrieved statistical distribution data.

14. The DOA estimation device of claim 13, wherein the number of sensors included in the sensor unit is equal to, or less than the number of sources.

15. The DOA estimation device of claim 13, wherein the statistical distribution data comprises data indicative of variation of the source signal over time and property changes.

16. The DOA estimation device of claim 13, wherein the calculated statistical distribution comprises at least one of Gaussian distribution, non-Gaussian distribution, Laplace distribution, and beamforming distribution.

17. The DOA estimation device of claim 13, wherein the controller calculates a cumulant matrix with the calculated statistical distribution data, and calculates the cumulant matrix using:
Kₓ_{ₖ}^{(ρ)}=Aₖ^{(ρ)}Dₛ_{ₖ}^{(ρ)}+K_{z}_{ₖ}^{(ρ)}
where, Kₓ_{ₖ}^{(ρ)} denotes a 2pth-order cumulant matrix in kth frequency bin, Aₖ^{(ρ)} denotes a virtual array manifold vector of kth frequency bin, and K_{z}_{ₖ}^{(ρ)} denotes a noise signal which is stationary.

18. The DOA estimation device of claim 13, wherein the controller comprises:
a pre-processor configured to convert the sensor signals into digital signals;
a signal analyzer configured to calculate statistical distribution data indicative of statistical distribution of the converted digital signals, retrieve statistical distribution data indicative of statistical distribution of the source signals by eliminating data about noise signal entrained in the signal from the calculated statistical distribution data, and calculate spatial spectrum about the number of sources of the digital signals and direction, using the retrieved statistical distribution data; and
a direction estimator configured to estimate the DOA based on peaks of the calculated spatial spectrum of the digital signals.

19. The DOA estimation device of claim 6, wherein the signal analyzer calculates the spatial spectrum using:
$${max}_{{( {w}_{k}^{( ρ )} )}_{θ}} {( {w}_{k}^{( ρ )} )}_{θ}^{H} {a}_{k}^{( ρ )} ( θ ) {( {a}_{k}^{( ρ )} ( θ ) )}^{H} {( {w}_{k}^{( ρ )} )}_{θ}$$
$${and \\ ( {w}_{k}^{( ρ )} )}_{θ}^{H} {{B}_{k}^{( ρ )} ( {w}_{k}^{( ρ )} )}_{θ} = {( {c}_{k}^{( ρ )} )}_{θ}$$
where, (wₖ^{(ρ)})_{θ} denotes a weight vector of kth frequency bin, αₖ^{(ρ)}(θᵢ) denotes a virtual array manifold vector of θᵢ in kth frequency bin, Bₖ^{(ρ)} denotes a non-singular matrix, and cₖ^{(ρ)} is an arbitrary nonzero real constant.

20. The DOA estimation device of claim 18, wherein the signal analyzer calculates the non-singular matrix Bₖ^{(ρ)} using the following mathematical expression, depending on whether the number of sources (I) is known, and when I is not known:
$${B}_{k}^{( ρ )} = \{ \begin{matrix}{U}_{s , k}^{( ρ )} ( {\sum }_{s , k}^{( ρ )} ) {( {U}_{s , k}^{( ρ )} )}^{H} + {α}_{k}^{( ρ )} {I}_{{M}^{2 ρ}} , known I \\ {C}_{{x}_{k}}^{( ρ )} + {α}_{k}^{( ρ )} {I}_{{M}^{2 ρ}} , unknown I\end{matrix}$$
where U_{s,k}^{(ρ)} is eigenvector [symbol] ( [symbol] ₓ_{ₖ}^{(ρ)}) which corresponds to a non-zero eigenvalue, Σ_{s,k}^{(ρ)} is eigenvector [symbol] ( [symbol] ₓ_{ₖ}^{(ρ)}) which corresponds to a zero eigenvalue, I denotes the number of) sources, I_{M}_{^{2ρ}} denotes a M^{2ρ}×M^{2ρ} unit matrix, αₖ^{(ρ)} is an eigenvector associated with eigenvalues corresponding to both eigenvector [symbol] ( [symbol] ₓ_{ₖ}^{(ρ)}) representing a source signal and eigenvector [symbol] ( [symbol] ₓ_{ₖ}^{(ρ)}) representing a noise signal, and [symbol] ₓ_{ₖ}^{(ρ)} is a noise-eliminated and dimension-adjusted 2pth-order cumulant matrix.

21. The DOA estimation device of claim 20, wherein, for the known I, the signal analyzer calculates the non-singular matrix Bₖ^{(ρ)} using the eigenvector U_{s,k}^{(ρ)} and the eigenvector Σ_{s,k}^{(ρ)}, calculates a Lagrange multiplier Gₖ^{(ρ)} using the calculated non-singular matrix Bₖ^{(ρ)}, calculates an optimum weight vector (wₖ^{(ρ)})_{θ,opt} using the calculated Gₖ^{(ρ)}, and calculates the eigenvector αₖ^{(ρ)} using the calculated (wₖ^{(ρ)})_{θ,opt} and the eigenvector U_{n,k}^{(ρ)}.

22. The DOA estimation device of claim 20, wherein, for the unknown I, the signal analyzer calculates the non-singular matrix Bₖ^{(ρ)} using the 2pth-order cumulant matrix [symbol] ₓ_{ₖ}^{(ρ)} calculates the Lagrange multiplier Gₖ^{(ρ)} using the calculated non-singular matrix Bₖ^{(ρ)}, calculates the optimum weight vector (wₖ^{(ρ)})_{θ,opt} using the calculated Gₖ^{(ρ)}, and calculates the eigenvector αₖ^{(ρ)} using the calculated (wₖ^{(ρ)})_{θ,opt} and the 2pth-order cumulant matrix [symbol] ₓ_{ₖ}^{(ρ)}.

23. The DOA estimation device of claim 20, wherein the direction estimator estimates the DOA based on a look direction of the source signal corresponding to the eigenvector αₖ^{(ρ)} having the largest non-singular value among the non-singular values calculated using the 2pth-order cumulant matrix [symbol] ₓ_{ₖ}^{(ρ)}.

24. A direction of arrival (DOA) estimation method, comprising:
detecting a signal and outputting sensor signals as a detect signal in response to the detected signal;
calculating statistical distribution data indicative of statistical distribution of each of the outputted sensor signals, respectively, and retrieving statistical distribution data indicative of statistical distribution of a source signal which is a non-stationary signal entrained in the signal of the calculated statistical distribution data; and
estimating DOA of the source signal based on the retrieved statistical distribution data.
